(19) United States
(12) Patent Application Publication
(10) Pub. No.: US 2019/0057373 A1
(43) Pub. Date: Feb. 21, 2019

(54) SYSTEMS, METHODS, AND DEVICES FOR COMPUTER-BASED LOCAL TRANSACTIONS

(71) Applicant: OFFERUP, INC., Bellevue, WA (US)

(72) Inventors: Arean VAN VEELEN, Issaquah, WA (US); Nicholas HUZAR, Renton, WA (US); Shiraz CUPALA, Snohomish, WA (US)

(21) Appl. No.: 15/735,867

(22) PCT Filed: Jun. 10, 2016
(86) PCT No.: PCT/US16/36947

§ 371 Date: Dec. 12, 2017

Related U.S. Application Data
(60) Provisional application No. 62/175,063, filed on Jun. 12, 2015.

(51) Int. Cl. G06Q 20/32; G06Q 20/40; G06Q 20/22; H04W 4/02

(52) U.S. Cl. CPC G06Q 20/3224; G06Q 20/40; H04W 4/023; G06Q 20/327; G06Q 20/223

(57) ABSTRACT

The present disclosure provides systems, methods, and devices for improved computer-based local transactions. In one aspect, a system, for improving reliability of a computer-based local transaction using a first user device and a second user device comprises one or more processors and memory including instructions executable by the one or more processors. The instructions, when executed, can generate one or more transaction parameters for the local transaction based on transaction data received from the first and second user devices. The one or more transaction parameters can comprise a payment amount for the local, transaction.

### CROSS-REFERENCE

This application claims the benefit of U.S. Provisional Application No. 62/175,063, filed Jun. 12, 2015, the disclosure of which is incorporated herein by reference in its entirety.

### BACKGROUND

A local transaction involves two parties (e.g., a buyer and a seller) meeting in person to physically exchange goods for payment. A local transaction can be initiated when a buyer and seller tentatively agree upon a price for an offered good. The buyer and seller can then arrange to meet in person to conduct the local transaction by exchanging payment for the offered good. During the in-person meeting, the buyer is able to physically inspect the offered good before making the final decision whether to approve the transaction and pay the seller. Online services such as online marketplaces, listings, etc. can be used by transacting parties to find and communicate with potential buyers and/or sellers in order to arrange local transactions.

In some instances, however, prior methods for local transactions can be less than ideal with respect to security, reliability, and convenience. For example, a transacting party may have no way of verifying the other party's identity and trustworthiness, and can be exposed to substantial risk of being robbed or scammed when meeting in person to finalize the transaction. Additionally, prior methods for local transactions may be limited to physical payment methods, such as cash or check payments. Cash payments can be inconvenient to obtain and risky for the buyer to carry, while check payments can be susceptible to fraud. Furthermore, in some instances, prior local transaction methods may not accommodate adjustments to the transaction amount during the in-person meeting.

Accordingly, improved systems, methods, and devices for local transactions are needed. The present disclosure addresses this need and more.

### SUMMARY

The present disclosure provides systems, methods, and devices for improved computer-based local transactions. In many embodiments, a computer-based local transaction utilizes digital processing devices as proxies for the parties participating in a local transaction (e.g., a buyer and a seller) in order to improve the reliability, flexibility, and security of such transactions. A transaction management system can be configured with instructions to determine whether two user devices have authorized a local transaction and automatically cause electronic transfer of the payment amount in response to the authorization with the two user devices, which can decrease the risks and user inconvenience associated with physical payment methods. The system can permit transaction parameters such as a payment amount to be modified before the transaction is finalized (e.g., to accommodate negotiations between buyer and seller), which provides greater flexibility and convenience. In many embodiments, the transaction management system determines whether the transacting user devices are in proximity to each other before the transaction can be conducted, which can reduce the incidence of fraud. Alternatively or in combination, the transaction management system can generate verification data such as one or more of digital tokens or security codes that are exchanged and validated by the user devices before the transaction can be conducted, thus providing an added layer of security to the transaction process.

In one aspect, a system for validating a computer-based local transaction using a first user device and a second user device is provided. The system can comprise one or more processors comprising memory. The memory can be configured with instructions executable by the one or more processors to cause the system to: receive localization information from one or more of the first user device or the second user device; process the localization information so as to determine whether the first and second user devices are in proximity to each other; and allow the first and second user devices to conduct the local transaction if the first and second user devices are determined to be in proximity to each other.

In some embodiments, the first and second user devices are determined to be in proximity to each other when the processed localization information indicates that the first and second user devices are within a target distance of each other. The target distance can be determined based on one or more of: a localization information type, an expected population density at a location where the local transaction is to be conducted, a number of other user devices at the location where the local transaction is to be conducted, or a distance between the first and second user devices when transaction data was received from the first and second user devices.

In some embodiments, the localization information comprises one or more of: position data, cell tower triangulation data, IP address data, or wireless access point data for one or more of the first user device or the second user device. The localization information can comprise a signal indicating that the first and second user devices are in communication with each other over a short range communication link.

In some embodiments, the instructions further cause the system to generate one or more transaction parameters for the local transaction based on transaction data received from the first and second user devices, wherein the one or more transaction parameters comprise a payment amount for the local transaction. The one or more transaction parameters can comprise a location where the local transaction is to be conducted, and the instructions can further cause the system to process the localization information so as to determine whether the first and second user devices are each at the location where the local transaction is to be conducted. The one or more transaction parameters can comprise a time when the local transaction is to be conducted, and the instructions can further cause the system to process the localization information so as to determine whether the first and second user devices are in proximity to each other at the time when the local transaction is to be conducted. The one or more transaction parameters can be generated prior to determining that the first and second user devices are in proximity to each other.

In some embodiments, the instructions further cause the system to: detect whether authorization to perform the local transaction according to the one or more transaction parameters has been received from the first and second user devices; and process the local transaction according to the one or more transaction parameters by causing transfer of the payment amount, in response to the received authorization.

In some embodiments, the one or more transaction parameters comprise a payment method for the local transaction, and the local transaction is processed by causing the transfer of the payment amount according to the payment method. The system can detect whether the authorization has been received in response to determining that the first and second user devices are in proximity to each other based on the processed localization information.

In some embodiments, the instructions further cause the system to: modify the one or more transaction parameters in response to a request received from one or more of the first user device or the second user device; detect whether authorization to perform the local transaction according to the modified one or more transaction parameters has been received from the first and second user devices; and process the local transaction according to the modified one or more transaction parameters, in response to the received authorization.

In some embodiments, the modified one or more transaction parameters comprise a modified payment amount different from the payment amount, and the local transaction is processed by causing transfer of the modified payment amount. The modified payment amount can be less or greater than the payment amount.

In some embodiments, the one or more transaction parameters comprise a first payment method for the local transaction, the modified one or more transaction parameters comprise a second payment method different from the first payment method, and the local transaction is processed by causing the transfer of the payment amount according to the second payment method.

In some embodiments, the instructions further cause the system to: cause the payment amount to be transferred from an account associated with one of the first user device or second user device to a reserve account, in response to the generated one or more transaction parameters; and process the local transaction by causing transfer of the payment amount from the reserve account. The instructions can further cause the system to transmit a notification to one or more of the first user device or the second user device indicating that the payment amount has been transferred to the reserve account.

In some embodiments, the instructions further cause the system to: modify the payment amount in response to a request received from one or more of the first user device or the second user device; detect whether authorization to perform the local transaction according to the modified payment amount has been received from the first and second user devices; and process the local transaction by causing transfer of the modified payment amount, wherein at least some of the modified payment amount is transferred from the reserve account.

In some embodiments, the first and second user devices each comprise a local application, and the one or more processors are configured to communicate with the first and second user devices with the respective local applications.

In some embodiments, the first and second user devices each comprise a mobile application, and the one or more processors are configured to communicate with the first and second user devices with the respective mobile applications.

In another aspect, a method for validating a computer-based local transaction using a first user device and a second. user device is provided. The method can comprise: receiving localization information from one or more of the first user device or the second user device; processing the localization information so as to determine whether the first and second user devices are in proximity to each other; and allowing the first and second user devices to conduct the local transaction if the first and second user devices are determined to be in proximity to each other.

In another aspect, a system for conducting a computer-based local transaction using a first user device and a second user device is provided. The system can comprise one or more processors comprising memory. The memory can be configured with instructions executable by the one or more processors to cause the system to: generate one or more transaction parameters for the local transaction based on transaction data received from the first and second user devices, wherein the one or more transaction parameters comprise a payment amount for the local transaction; modify the one or more transaction parameters in response to a request received from one or more of the first user device or the second user device; detect whether authorization to perform the local transaction according to the modified one or more transaction parameters has been received from the first and second user devices; and process the local transaction according to the modified one or more transaction parameters, in response to the received authorization.

In some embodiments, the modified one or more transaction parameters comprise a modified payment amount different from the payment amount, and the local transaction is processed by causing transfer of the modified payment amount. The modified payment amount can be less than or greater than the payment amount.

In some embodiments, the one or more transaction parameters comprise a first payment method for the local transaction, the modified one or more transaction parameters comprise a second payment method different from the first payment method, and the local transaction is processed by causing the transfer of the payment amount according to the second payment method.

In some embodiments, the instructions further cause the system to cause the pay rent amount to be transferred from an account associated with one of the first user device or second user device to a reserve account, in response to the generated one or more transaction parameters. The instructions can further cause the system to transmit a notification to one or more of the first user device or the second user device indicating that the payment amount has been transferred to the reserve account. The instructions can further cause the system to process the local transaction by causing transfer of the modified payment amount. At least some of the modified payment amount can be transferred from the reserve account.

In some embodiments, the instructions further cause the system to process localization information received from one or more of the first user device or the second user device so as to determine whether the first and second user devices are in proximity to each other. The first and second user devices can be determined to be in proximity to each other when the processed localization information indicates that the first and second user devices are within a target distance of each other. The target distance can be determined based on one or more of: a localization information type, an expected population density at a location where the local transaction is to be conducted, a number of other user devices at the location where the local transaction is to be conducted, or a distance between the first and second user devices when the transaction data was received.

In some embodiments, the localization information comprises one or more of: position data, cell tower triangulation data, IP address data, or wireless access point data for one or mare of the first user device or the second user device. The localization information can comprise a signal indicating that the first and second user devices are in communication with each other over a short range communication link.

In some embodiments, the one or more transaction parameters comprise a location where the local transaction is to be conducted, and the instructions further cause the system to process the localization information so as to determine whether the first and second user devices are each at the location where the local transaction is to be conducted.

In sonic embodiments, the one or more transaction parameters comprise a time when the local transaction is to be conducted, and the instructions further cause the system to process the localization information so as to determine whether the first and second user devices are in proximity to each other at the time when the local transaction is to be conducted.

In some embodiments, the one or more transaction parameters are generated prior to determining that the first and second user devices are in proximity to each other.

In some embodiments, the first and second user devices each comprise a local application, and the one or more processors are configured to communicate with the first and second user devices with the respective local applications.

In some embodiments, the first and second user devices each comprise a mobile application, and the one or more processors are configured to communicate with the first and second user devices with the respective mobile applications.

In another aspect, a method for conducting a computer-based local transaction using a first user device and a second user device is provided. The method can comprise: generating one or more transaction parameters for the local transaction based on transaction data received from the first and second user devices, wherein the one or more transaction parameters comprise a payment amount for the local transaction; modifying the one or more transaction parameters in response to a request received from one or more of the first user device or the second user device; detecting whether authorization to perform the local transaction according to the modified one or more transaction parameters has been received from the first and second user devices; and processing the local transaction according to the modified one or more transaction parameters, in response to the received authorization.

In another aspect, a system for validating a computer-based local transaction using a first user device and a second user device is provided. The system can comprise one or more processors comprising memory. The memory can be configured with instructions executable by the one or more processors to cause the system to: generate one or more transaction parameters for the local transaction based on transaction data received from the first and second user devices, wherein the one or more transaction parameters comprise a payment amount for the local transaction; generate one or more digital tokens based on the one or more transaction parameters; and transmit the one or more digital tokens to each of the first and second user devices. The one or more digital tokens can be configured with instructions to permit the first and second user devices to conduct the local transaction in response to the first and second user devices exchanging and validating their respective digital tokens with each other.

In some embodiments, the one or more digital tokens are configured with instructions to permit the first and second user devices to conduct the local transaction independently of the one or more processors when each of the first and second user devices has received the one or more digital tokens.

In some embodiments, the one or more digital tokens are configured with instructions to permit the first and second user devices to conduct the local transaction without being connected to the one or more processors when each of the first and second user devices has received the one or more digital tokens.

In some embodiments, the one or more digital tokens comprise one or more transaction requirements for the local transaction, and the one or more digital tokens are configured with instructions to permit the first and second user devices to conduct the local transaction in response to a determination that the one or more transaction requirements have been fulfilled. The one or more transaction requirements can comprise one or more of: the first and second user devices being in proximity to each other, the local transaction occurring at a predetermined location, the local transaction occurring at a predetermined time, a maximum payment amount for the local transaction, or a minimum payment amount for the local transaction.

In another aspect, a method for validating a computer-based local transaction using a first user device and a second user device is provided. The method can comprise: generating one or more transaction parameters for the local transaction based on transaction data received from the first and second user devices, wherein the one or more transaction parameters comprise a payment amount for the local transaction; generating one or more digital tokens based on the one or more transaction parameters; and transmitting the one or more digital tokens to each of the first and second user devices. The one or more digital tokens can be configured with instructions to permit the first and second user devices to conduct the local transaction in response to the first and second user devices exchanging and validating their respective digital tokens with each other

In another aspect, a system for validating a computer-based local transaction using a first user device and a second user device is provided. The system can comprise one or more processors comprising memory. The memory can be configured with instructions executable by the one or mare processors to cause the system to: generate one or more transaction parameters for the local transaction based on transaction data received from the first and second user devices, wherein the one or more transaction parameters comprise a payment amount for the local transaction; generate one or more security codes based on the one or more transaction parameters; and transmit the one or more security codes to each of the first and second user devices. The one or more security codes can be configured to permit the first and second user devices to conduct the local transaction in response to the first and second user devices exchanging and validating their respective security codes with each other.

In another aspect, a method for validating a computer-based local transaction using a first user device and a second user device is provided. The method can comprise: generating one or more transaction parameters for the local transaction based on transaction data received from the first and second user devices, wherein the one or more transaction parameters comprise a payment amount for the local transaction; generating one or more security codes based on the one or more transaction parameters; and transmitting the one or more security codes to each of the first and second user devices. The one or more security codes can be configured to permit the first and second user devices to conduct the local transaction in response to the first and second user devices exchanging and validating their respective security codes with each other.

In another aspect, a system for improving reliability of a computer-based local transaction using a first user device and a second user device is provided. The system can comprise one or more processors comprising memory configured with instructions executable by the one or more processors to cause the system to generate one or more transaction parameters for the local transaction based on transaction data received from the first and second user devices. The one or more transaction parameters can comprise a payment amount for the local transaction.

In some embodiments, the first and second user devices each comprise a local application, and the one or more processors are configured to communicate with the first and second user devices with the respective local applications. Alternatively or in combination, the first and second user devices can each comprise a mobile application, and the one or more processors can be configured to communicate with the first and second user devices with the respective mobile applications.

In some embodiments, the instructions further cause the system to detect whether authorization to perform the local transaction according to the one or more transaction parameters has been received from the first and second user devices. The system can process the local transaction according to the one or more transaction parameters by causing transfer of the payment amount, in response to the received authorization. The one or more transaction parameters can comprise a payment method for the local transaction, for example, and the local transaction can be processed by causing the transfer of the payment amount according to the payment method.

In some embodiments, the instructions further cause the system to modify the one or more transaction parameters in response to a request received from one or more of the first user device or the second user device. The system can detect whether authorization to perform the local transaction according to the modified one or more transaction parameters has been received from the first and second user devices. The system can process the local transaction according to the modified one or more transaction parameters, in response to the received authorization. The modified one or more transaction parameters can comprise a modified payment amount different from the payment amount, for example, and the local transaction can be processed by causing transfer of the modified payment amount. The modified payment amount can be less than or greater than the payment amount.

In some embodiments, the one or more transaction parameters comprise a first payment method for the local transaction, the modified one or more transaction parameters comprise a second payment method different from the first payment method, and the local transaction is processed by causing the transfer of the payment amount according to the second payment method.

In some embodiments, the instructions further cause the system to cause the payment amount to be transferred from an account associated with one of the first user device or second user device to a reserve account, in response to the generated one or more transaction parameters. The system can process the local transaction by causing transfer of the payment amount from the reserve account. The instructions can further cause the system to transmit a notification to one or more of the first user device or the second user device indicating that the payment amount has been transferred to the reserve account.

In some embodiments, the instructions further cause the system to modify the payment amount in response to a request received from one or more of the first user device or the second user device. The system can detect whether authorization to perform the local transaction according to the modified payment amount has been received from the first and second user devices, and process the local transaction by causing transfer of the modified payment amount. Optionally, at least some of the modified payment amount is transferred from the reserve account.

In some embodiments, the instructions further cause the system to process localization information received from one or more of the first user device or the second user device so as to determine whether the first and second user devices are in proximity to each other. The system can detect whether the authorization has been received in response to determining that the first and second user devices are in proximity to each other based on the processed localization information. For example, the first and second user devices can be determined to be in proximity to each other when the processed localization information indicates that the first and second user devices are within a target distance of each other. The target distance can be determined based on one or more of: a localization information type, an expected population density at a location where the local transaction is to be conducted, a number of other user devices at the location where the local transaction is to be conducted, or a distance between the first and second user devices when the transaction data was received.

In some embodiments, the localization information comprises one or more of: position data, cell tower triangulation data, IP address data, or wireless access point data for one or more of the first user device or the second user device. Alternatively or in combination, the localization information can comprise a signal indicating that the first and second user devices are in communication with each other over a short range communication link.

In some embodiments, the one or more transaction parameters comprise a location where the local transaction is to be conducted, and the instructions further cause the system to process the localization information so as to determine whether the first and second user devices are each at the location where the local transaction is to be conducted. Alternatively or in combination, the one or more transaction parameters can comprise a time when the local transaction is to be conducted, and the instructions can further cause the system to process the localization information so as to determine whether the first and second user devices are in proximity to each other at the time when the local transaction is to be conducted. Optionally, the one or more transaction parameters are generated prior to determining that the first and second user devices are in proximity to each other.

In some embodiments, the instructions further cause the system to generate one or more digital tokens based on the one or more transaction parameters and transmit the one or more digital tokens to each of the first and second user devices. The one or more digital tokens can be configured with the instructions to permit the first and second user devices to conduct the local transaction in response to the first and second user devices exchanging and validating their respective digital tokens with each other. For instance, the one or more digital tokens can be configured with the instructions to permit the first and second user devices to conduct the local transaction independently of the one or more processors when each of the first and second user devices has received the one or more digital tokens. The one or more digital tokens can be configured with the instructions to permit the first and second user devices to conduct the local transaction without being connected to the one or more processors when each of the first and second user devices has received the one or more digital tokens.

In some embodiments, the one or more digital tokens comprise one or more transaction requirements for the local transaction, and the one or more digital tokens are configured with instructions to permit the first and second user devices to conduct the local transaction in response to a determination that the one or more transaction requirements have been fulfilled. The one or more transaction requirements can comprise one or more of: the first and second user devices being in proximity to each other, the local transaction occurring at a predetermined location, the local transaction occurring at a predetermined time, a maximum payment amount for the local transaction, or a minimum payment amount for the local transaction.

In some embodiments, the instructions further cause the system to generate one or more security codes based on the one or more transaction parameters and transmit the one or more security codes to each of the first and second user devices. The one or more security codes can be configured to permit the first and second user devices to conduct the local transaction in response to the first and second user devices exchanging and validating their respective security codes with each other.

In another aspect, a method comprises providing a system as in any one of the embodiments presented herein.

In another aspect, a method for improving reliability of a computer-based local transaction using a first user device and a second user device is provided. The method can comprise generating one or more transaction parameters for the local transaction based on transaction data received from the first and second user devices, the one or more transaction parameters comprising a payment amount for the local transaction.

In another aspect, a mobile device for improving reliability of a computer-based local transaction conducted with a second mobile device is provided. The mobile device can comprise one or more processors comprising memory configured with instructions executable by the one or more processors to cause the mobile device to generate transaction data for a local transaction, wherein the transaction data comprises a payment amount for the local transaction, and transmit the transaction data to a server.

In some embodiments, the mobile device is configured with the instructions to receive one or more digital tokens from the server and transmit the one or more digital tokens to the second mobile device. The mobile device can receive and validate a second one or more digital tokens from the second mobile device and conduct the local transaction in response to validation of the second one or more digital tokens.

In another aspect, a mobile device for improving reliability of a computer-based local transaction with a second mobile device is provided. The mobile device can comprise a display comprising a user interface configured to receive a user input, and one or more processors comprising memory configured with instructions executable by the one or more processors to cause the mobile device to receive the user input and transmit a signal to the second mobile device in response to the user input.

In another aspect, a system for improving reliability of a computer-based local transaction using a first user device and a second user device is provided. The system can comprise one or more processors comprising memory configured with instructions executable by the one or more processors to provide a user interface on a display of one or more of the first user device or the second user device.

Additional features of the present disclosure will become apparent by a review of the specification, claims, and appended figures.

### INCORPORATION BY REFERENCE

All publications, patents, and patent applications mentioned in this specification are herein incorporated by reference in their entirety to the same extent as if each individual publication, patent, or patent application was specifically and individually indicated to be incorporated, by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a system architecture for computer-based local transactions, in accordance with embodiments;

FIG. 2A illustrates a server-based method for computer-based local transactions performed by a transaction management system, in accordance with embodiments;

FIG. 2B illustrates a server-based method for computer-based local transactions performed by a user device, in accordance with embodiments;

FIGS. 3A and 3B illustrate a processing flow for a server-based method for computer-based local transactions, in accordance with embodiments;

FIG. 4 illustrates a method for proximity detection using a transaction management system, in accordance with embodiments;

FIG. 5A illustrates a client-based method for computer-based local transactions performed by a user device, in accordance with embodiments;

FIG. 5B illustrates a client-based method for computer-based local transactions performed by a transaction management system, in accordance with embodiments;

FIGS. 6A through 6C illustrate a processing flow for a client-based method for computer-based local transactions, in accordance with embodiments;

FIG. 7 illustrates a user interface for displaying a transaction posting, in accordance with embodiments;

FIG. 8 illustrates a user interface for submitting a transaction offer, in accordance with

[symbol]

FIG. 9 illustrates a user interface for displaying and selecting a transaction offer, in accordance with embodiments;

FIG. 10 illustrates a user interface for communicating with a transacting party, in accordance with embodiments;

FIG. 11 illustrates a user interface for modifying transaction parameters, in accordance with embodiments;

FIG. 12 illustrates a user interface for displaying a transaction confirmation, in accordance with embodiments;

FIG. 13 illustrates a user interface for displaying a transaction receipt, in accordance with embodiments;

FIG. 14 illustrates a user interface for submitting a reservation offer, in accordance with embodiments;

FIG. 15 illustrates a user interface for displaying and approving a reservation offer, in accordance with embodiments; and

FIG. 16 illustrates a user interface for authorizing a modified reserve offer payment amount, in accordance with embodiments.

### DETAILED DESCRIPTION

The systems, methods, and devices of the present disclosure provide improvements to the reliability, flexibility, and security of local transactions performed with the aid of digital processing devices, also referred to herein as “computer-based local transactions.” In some embodiments, digital processing devices (e.g., mobile devices, smartphones, wearable devices such as smart watches, tablets, laptop computers, personal computers, etc.) are used to initiate and/or conduct a computer-based local transaction. “Initiating a local transaction” may refer herein to steps and processes involved in setting up a local transaction, e.g., creating a transaction posting indicating a good for sale, creating a transaction offer indicating a proposed payment amount for an offered good, accepting a transaction offer, arranging a time and location to meet in person, etc. In some embodiments, initiation of a local transaction occurs before the buyer and seller actually meet in person. In alternative embodiments, a local transaction may be partially or wholly initiated after the buyer and seller have met in person (e.g., the buyer decides to purchase another item from the seller after meeting). “Conducting a local transaction” may refer herein to steps and processes that occur after the buyer and seller have met in person, e.g., negotiating the final payment amount, authorizing the final payment amount for the transaction, effecting transfer of the payment, transferring the good to complete the transaction, etc. In some embodiments, a transaction management system mediates various aspects of initiating and conducting computer-based local transactions using digital processing devices in order to improve the reliability, security, and flexibility of such transactions.

Although various embodiments herein are described in the context of local transactions involving goods, this is not intended to be limiting, and a person of ordinary skill in the art would appreciate that the present disclosure is equally applicable to other types of local transactions, e.g., local transactions involving non-tangible products, property, services, etc.

System Architecture

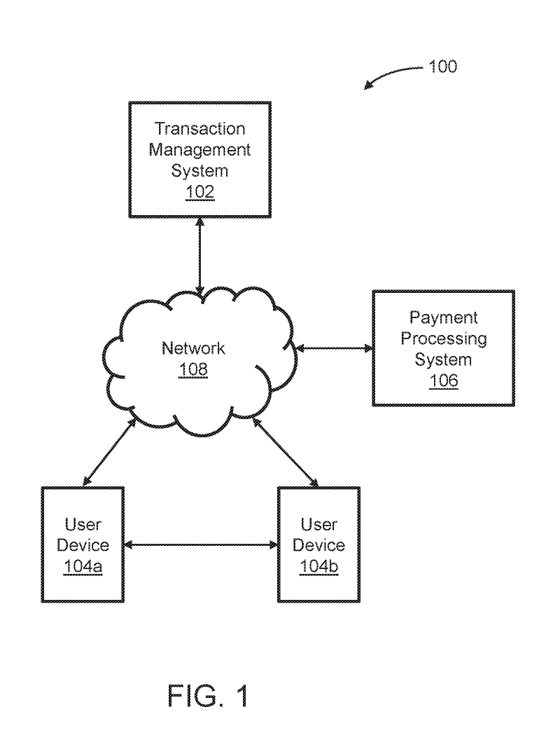

Turning now the drawings, FIG. 1 illustrates a system architecture 100 for computer-based local transactions, in accordance with embodiments. The system architecture 100 can include a transaction management system 102, a plurality of user devices 104a-b, and a payment processing system 106 connected to each other via a network 108. The transaction management system 102 can include a server (also referred to herein as a “computer system” or “computing system”) configured to implement the various methods described herein. The server can include one or more of the digital processing devices or components thereof, as described further herein. For example, the server can include a central processing unit (CPU, also “processor” and “computer processor” herein), which can be a single core or multi core processor, or a plurality of processors for parallel processing. The server can also include memory (e.g., random-access memory, read-only memory, flash memory), data storage devices (e.g., hard disks), communications interfaces (e.g., network adapters) for communicating with one or more other systems and/or devices, and/or peripheral devices (e.g., cache, other memory, data storage and/or electronic display adapters). The memory can include instructions executable by the one or more processors of the transaction management system 102 to perform the methods described herein. In some embodiments, the transaction management system 102 is implemented as a distributed “cloud” computing system across any suitable combination of hardware and/or virtual computing resources.

The transaction management system 102 can be configured to communicate with a plurality of user devices 104a-b used to perform a local transaction. Although FIG. 1 depicts two user devices 104a-b, it shall be appreciated that the system 100 can be configured to accommodate any number of user devices. The term “user device” may be used herein to refer to a digital processing device associated with (e.g., belonging to and/or carried by) a user or party involved in a local transaction. For example, the user device 104a can be a device associated with a buyer in a particular transaction and the user device 104b can be a device associated with a seller in the transaction, or vice-versa. In some embodiments, a local transaction involves a single buyer user device and a single seller user device communicating with each other and/or the transaction management system 102. In alternative embodiments, a plurality of different buyer user devices and/or a plurality of different seller user devices can be used to perform a local transaction, such that different steps of the transaction procedure are performed by different devices. For instance, a user can use a first user device to conduct a first part of the transaction and a second, different user device to conduct a second part of the transaction. Optionally, each user of the transaction management system 102 can have a user account registered with the transaction management system 102, and each user can link or otherwise associate one or more user devices with the user account. In such embodiments, a local transaction can be conducted using any combination of the user devices associated with the transacting party's user account. It shall be appreciated that any method described herein as being performed between two user devices (e.g., a single buyer user device and a single seller user device) can also be performed using more than two user devices (e.g., a plurality of buyer user devices associated with a buyer account and/or a plurality of seller user devices associated with a seller account), and vice-versa.

In some embodiments, the user devices 104a-b are mobile devices (e.g., smartphones, tablet computers, laptop computers, personal digital assistants, wearable computing devices, handheld computing devices, etc.), such that the transacting parties are able to bring their user devices to the physical location where the local transaction is to be conducted. Each user device can include one or more processors and memory configured with instructions to enable the user device to perform the various methods presented herein. For example, the user devices 104a-b can each include a local software application (e.g., a mobile application or “mobile app”) configured to perform the methods described herein, e.g., provide a user interface for receiving user input and/or displaying output, transmit data to the transaction management system 102 and/or another user device, receive data from the transaction management system 102 and/or another user device, etc. Alternatively or in combination, the user device 104a-b can be used to access a web-based software application (“web app”) configured to perform the methods herein. Additionally, each user device can include a display (e.g., monitor, touchscreen, etc.) and a user input device (e.g., keyboard, mouse, touchscreen, etc.) configured to provide a user interface to receive user input and display output to the user, in accordance with embodiments herein.

The transaction management system 102 can communicate with the user devices 104a-b via a network 108. The network 108 can include the Internet, intranet networks, extranet networks, telecommunications networks, cellular networks, data networks, virtual private networks (VPNs), wireless networks, local area networks (LANs), wide area networks (WANs), or combinations thereof. The transaction management system 102 and user devices 104a-b can be connected to the network 108 using wired and/or wireless communication technologies. Communication between the transaction management system 102 and the user devices 104a-b via the network 108 can generally conform to a client-server model, in which the transaction management system 102 (server) provides services and/or resources related to local transactions in response to requests from the user devices 104a-b (clients). Certain embodiments of the present disclosure provide a server-based implementation for initiating and conducting local transactions, while other embodiments provide a client-based implementation, as described further herein.

In addition to communicating with the transaction management system 102, the user devices 104a-b can also be configured to communicate with each other, e.g., via the network 108 or directly without going through the network 108. Direct communication between the user devices 104a-b can involve various types of communication methods, such as short range wireless communication (e.g., Bluetooth®, near field communication, etc.), and can be mediated by a local application (e.g., mobile app) and/or web application installed on the respective devices. Direct communication between user devices 104a-b can be utilized in client-based implementations of computer-based local transactions, as described in further detail herein.

In some embodiments, the transaction management system 102 is communicably coupled to a payment processing system 106 via the network 108. The payment processing system 106 can include one or more servers configured to process and perform electronic financial transactions, e.g., transfer payment from a buyer account to a seller account, place an authorization hold on an account, etc. The various embodiments presented herein can be used with various types of electronic payment processing systems, including but not limited to Automated Clearing House (ACH) systems, electronic funds transfer (EFT) systems, e-commerce payment systems (e.g., PayPal®, Google Wallet®, Apple Pay®, Venmo®, Square®, Stripe®, Braintree®, etc.), or credit card systems (e.g., systems associated with a credit card acquirer or issuer). Alternatively or in combination, the payment processing system 106 can accommodate physical payment methods (e.g., receiving a physical check from a buyer and/or issuing a physical check to a seller). In some embodiments, the transaction management system 102 communicates with the payment processing system 106 in order to process and complete a local transaction by authorizing transfer of a payment amount from a buyer account to a seller account (e.g., via ACH to a seller's bank account or e-commerce account, issuing a physical check, etc.). The transaction management system 102 can also communicate with the payment processing system 106 in order to perform one or more the following functions: place an authorization hold on a buyer account, remove an authorization hold from a buyer account, transfer a payment amount from a buyer account to a reserve account, transfer a payment amount from a reserve account to a buyer account, and/or transfer a payment amount from a reserve account to a seller account, as discussed further herein. Optionally, the transaction management system 102 can communicate with the payment processing system 106 to validate payment information for a user device (e.g., whether the credit card information provided by a user device is valid, whether a buyer account includes sufficient funds for an transaction, etc.),

Server-Based Implementation for Computer-Based Local Transactions

Some embodiments of the present disclosure provide server-based implementations or methods for performing computer-based local transactions using user devices. In such embodiments, the user devices are connected to and interact with the transaction management system while the transaction is being conducted (e.g., when the buyer and seller are meeting in person). The transaction management system may be responsible for mediating certain key steps in the local transaction process, such as validating the devices for the transaction, checking that authorization for the transaction has been received from both user devices, processing the transaction by effecting payment transfer, and/or transmitting transaction confirmation to the user devices. In some embodiments of the server-based implementation, the user devices may not be able to conduct the local transaction if both devices are not connected to the transaction management system.

It shall be understood that the discussion of certain embodiments in the context of server-based implementations is not intended to be limiting, and that any of the steps or components described herein with respect to a server-based implementation are equally applicable to and can be used in combination with any other implementation, such as the client-based implementations presented herein, and vice-versa.

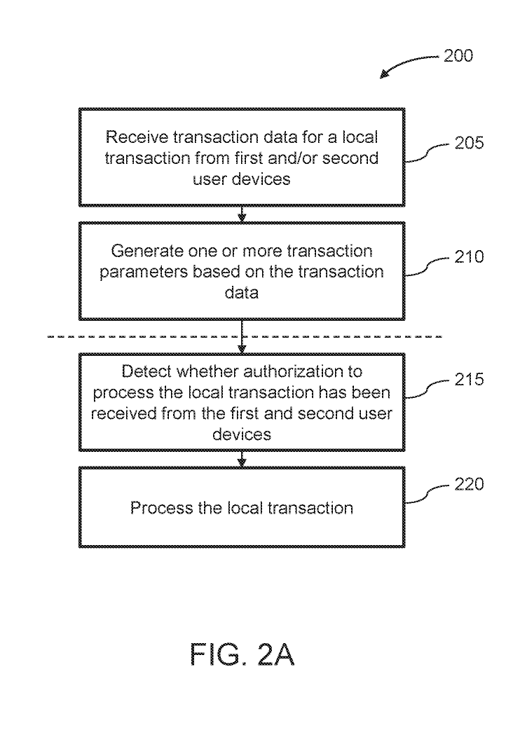

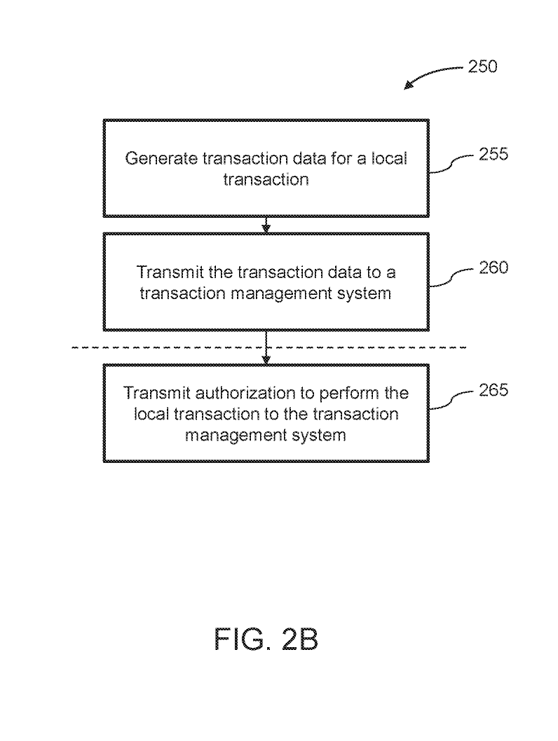

FIG. 2A illustrates a server-based method 200 for computer-based local transactions performed by a transaction management system, in accordance with embodiments. The steps of the method 200 can be performed by one or more processors of a transaction management system, e.g., the transaction management system 102 of the system 100. The transaction management system can be in communication with two transacting user devices, e.g., via a local application such as a mobile app installed on the user devices. Data can be received from and transmitted to the user devices via a network, as described herein.

In step 205, transaction data for a local transaction is received from first and/or second user devices. The transaction data can include data related to a local transaction that has yet to be conducted (e.g., the buyer and seller have not yet met in person). Examples of such transaction data include but are not limited to: the name of an offered good, a description of the offered good, a payment amount for the offered good, a payment method to be used for the transaction, a location where the transaction is to be conducted, a time where the transaction is to be conducted, identification information for the first and/or second user devices involved in the transaction, and/or account information for user accounts associated with the first and/or second user devices. In some embodiments, transaction data is generated by the first and/or second user devices during the process of initiating a local transaction, e.g., creating a transaction posting offering a good for sale, creating a transaction offer responding to a transaction posting with a proposed payment amount, and/or accepting a transaction offer. The transaction management system can receive and store the transaction data generated by the first and/or second user devices during these interactions. Alternatively or in combination, the transaction data can include data generated after the transaction has been initiated. For instance, after a transaction offer has been accepted, the buyer and seller can determine a time and location for the transaction to be conducted, and communicate this information to the transaction management system via the user devices.

In step 210, one or more transaction parameters are generated based on the transaction data. The transaction parameters can be for a local transaction that has been initiated but not yet conducted. Examples of transaction parameters include but are not limited to: the name of an offered good, a description of the offered good, a payment amount for the offered good, a payment method to be used for the transaction, a location where the transaction is to be conducted, a time where the transaction is to be conducted, identification information for the first and/or second user devices involved in the transaction, and/or account information for user accounts associated with the first and/or second user devices. In some embodiments, the transaction management system processes the transaction data received from the first and/or second user devices in order to determine the appropriate parameters for the transaction. For instance, in response to receiving a notification that a transaction offer has been accepted, the transaction management system can process the offer to determine a proposed payment amount for the transaction to be conducted. As another example, the transaction management system can process communications between the first and second user devices to determine whether a time and/or location for the transaction has been specified. The generated transaction parameters can be stored in a data storage device associated with the transaction management system.

In step 215, it is detected whether authorization to perform the local transaction has been received from the first and second user devices. The authorization can be indicative of approval from both the transacting parties to perform the local transaction according to one or more transaction parameters. For example, the first user device can transmit an authorization indicative of a proposed payment amount for the transaction, and the second user device can transmit an authorization indicative of approval of the proposed payment amount. As another example, the first user device can transmit an authorization indicative of a proposed payment method for the transaction, and the second user device can transmit an authorization indicative of approval of the proposed payment method.

In some embodiments, some or all of the authorized transaction parameters are the same transaction parameters generated in step 210. This may indicate that the buyer and seller have agreed to perform the local transaction according to the parameters that were initially agreed upon in the accepted transaction offer. Alternatively or in combination, some or all of the authorized transaction parameters may be different from the previously generated transaction parameters. This may indicate that the buyer and seller have modified one or more parameters from the accepted transaction offer. For instance, the buyer and/or seller may modify the proposed payment amount, e.g., if the buyer physically inspects the offered good and decides that the initial price was too high, if the buyer and seller renegotiate the price during the in-person meeting, etc.

In such embodiments, the method 200 further includes an optional step of modifying the one or more transaction parameters generated in step 210 in response to a request received from the first and/or second user devices. The modified transaction parameters can include a modified payment amount (e.g., greater than or less than an amount specified in step 210) and/or a modified payment method (e.g., different from the method specified in step 210). Accordingly, step 215 can involve detecting whether authorization to perform the local transaction according to the modified transaction parameters has been received from the first and second user devices, in order to ensure that both transacting parties have agreed to the proposed modifications. This approach can be used to accommodate ad hoc negotiations that may occur during an in-person meeting, thus enhancing flexibility and convenience.

Optionally, the method 200 can include additional validation performed in combination with step 215, and the transaction may be permitted to proceed only if the additional validation is successful. For instance, the transaction management system can perform further checks on the authorized transaction parameters, such as whether the authorized payment amount is within an expected range. An authorized payment amount that is significantly greater or less than the initial amount in the accepted transaction offer may be indicative of fraudulent activity. The transaction management systems can be configured to prevent modification of the payment amount beyond a predetermined minimum and/or maximum amount. As another example, the transaction management system can receive data indicative of the identity of the good from the first and/or second user devices (e.g., an image of the good, a scan of an identifier or barcode associated with the good, etc.) to confirm that the buyer is receiving the correct item. This can he beneficial for preventing scams in which an unscrupulous seller brings a different good to the local transaction than what was initially offered in the transaction posting.

In step 220, the local transaction is processed. The local transaction can be processed according to the transaction parameters authorized by the first and second user devices in step 215, which may or may not have been modified relative to the parameters generated in step 210 as discussed herein. For instance, processing of the local transaction can involve causing an authorized payment amount to be transferred, e.g., from an account associated with a buyer to an account associated with a seller. In some embodiments, the payment transfer is performed in accordance with a specified payment method (e.g., credit card, debit card, PayPal®, Google Wallet®, Apple Pay®, Venmo®, Square®, Stripe®, Braintree®, etc.), such as a payment method specified by the authorized transaction parameters in step 215. The transaction management system can process the local transaction by transmitting instructions to a payment processing system in order to effect the payment transfer according to the payment method, as discussed above and herein. Optionally, the payment processing system can respond to the transaction management system by confirming whether the payment transfer was successful, and this confirmation can be subsequently communicated to the first and second user devices (e.g., as a displayable transaction receipt). Once the user devices have received confirmation that the local transaction was successfully processed, the offered good can be transferred from the seller to the buyer in order to complete the local transaction.

The timing of the steps of the method 200 may be related to the stage of the local transaction. In some embodiments, as indicated by the dashed tine, steps 205 and 210 are performed before the local transaction has been conducted (e.g., before the buyer and seller have met in person to conduct the transaction), while steps 215 and 220 are performed when the local transaction is being conducted (e.g., during the in-person meeting between the buyer and seller). The transaction management system can be configured to determine whether the transaction is being conducted and automatically proceed to step 215 if appropriate. For instance, the transaction management system can receive an input signal from the first and/or second user devices indicating that the transaction is being conducted (e.g., user input indicating that the buyer is with the seller and is ready to proceed). Optionally, the transaction management system can use other methods besides user input to detect whether the transaction is being conducted (e.g., localization information, as discussed further herein). In alternative embodiments, the method 200 can be performed without considering the stage of the local transaction.

FIG. 2B illustrates a server-based method 250 for computer-based local transactions performed by a user device, in accordance with embodiments. The steps of the method 250 can be performed by one or more processors of a user device involved in a computer-based local transaction, e.g., user device 104a or 104b of the system 100. The user device can be in communication with a transaction management system, such as a transaction management system configured to perform the method 200. In some embodiments, all of the steps of the method 250 are performed using a single user device. Alternatively, some or all of the steps of the method 250 can be performed using a plurality of different user devices (e.g., a plurality of user devices associated with the same user account).

In step 255, transaction data for a local transaction is generated. The transaction data can be similar to the transaction data described herein with respect to step 205 of the method 200. Exemplary transaction data can include one or more of: the name of an offered good, a description of the offered good, a payment amount for the offered good, a payment method to be used for the transaction, a location where the transaction is to be conducted, a time where the transaction is to be conducted, identification information for the first and/or second user devices involved in the transaction, and/or account information for user accounts associated with the first and/or second user devices. The transaction data can be generated based on user input received via a displayed user interface, such as a user interface generated by a local application and/or web application on the user device. Such user input can be received during the process of initiating a local transaction (e.g., creating a transaction posting offering a good for sale, creating a transaction offer responding to a transaction posting with a proposed payment amount, and/or accepting a transaction offer) and/or after the transaction has been initiated, as discussed herein.

In step 260, the transaction data is transmitted to a transaction management system, e.g., via a network. Steps 255 and 260 can be performed prior to step 205 of the method 200, such that the transaction management system received and responds to the transaction data generated by the user device.

In step 265, authorization to perform the local transaction is transmitted to the transaction management system. The authorization can be transmitted in response to receiving user input indicating approval to perform the local transaction according to one or more transaction parameters. For instance, the user device can provide a user interface displaying one or more proposed parameters for the transaction (e.g., a payment amount and/or method), and the user input can indicate acceptance or rejection of the proposed parameters. In some embodiments, the transaction parameters are generated by the transaction management system based on the transaction data generated and transmitted in steps 255 and 260. Generation of transaction parameters can be performed as discussed herein with respect to step 210 of the method 200.

In some embodiments, the method 250 includes an optional step of transmitting a. request to the transaction management system to modify one or more transaction parameters for the local transaction system. The request can be generated based on user input received from a displayed user interface indicative of a proposed modification to one or more parameters (e.g., an increased or decreased payment amount). The user device may be subsequently prompted by the transaction management system to provide authorization for performing the local transaction according to the modified parameters. Alternatively, the transmittal of a requested modification may be treated as an authorization.

Similar to the method 200, the timing of the steps of the method 250 may be related to the stage of the local transaction. In some embodiments, as indicated by the dashed line, steps 255 and 260 are performed before the local transaction has been conducted, while step 260 is performed when the local transaction is being conducted. The user device can be configured to determine whether the transaction is being conducted and automatically proceed to step 260 if appropriate, by displaying an authorization user interface for receiving user input authorizing the transaction. For instance, the user device can receive an input signal from the user indicating that the transaction is being conducted (e.g., user input indicating that the buyer is with the seller and is ready to proceed). Optionally, the user device can use other methods besides user input to detect whether the transaction is being conducted (e.g., localization information, as discussed further herein). In some embodiments, the user device receives a signal from the transaction management system indicating that the transaction is being conducted and automatically proceeds to step 260 in response to the signal. In alternative embodiments, the method 250 can be performed without considering the timing of the local transaction.

In such embodiments, one or more steps of the method 250 can be performed in coordination with one or more steps of the method 200. For example, steps 255 and 260 of the method 250 can be performed prior to step 205 of the method 200, and step 265 of the method 250 can be performed prior to step 215 of the method 200.

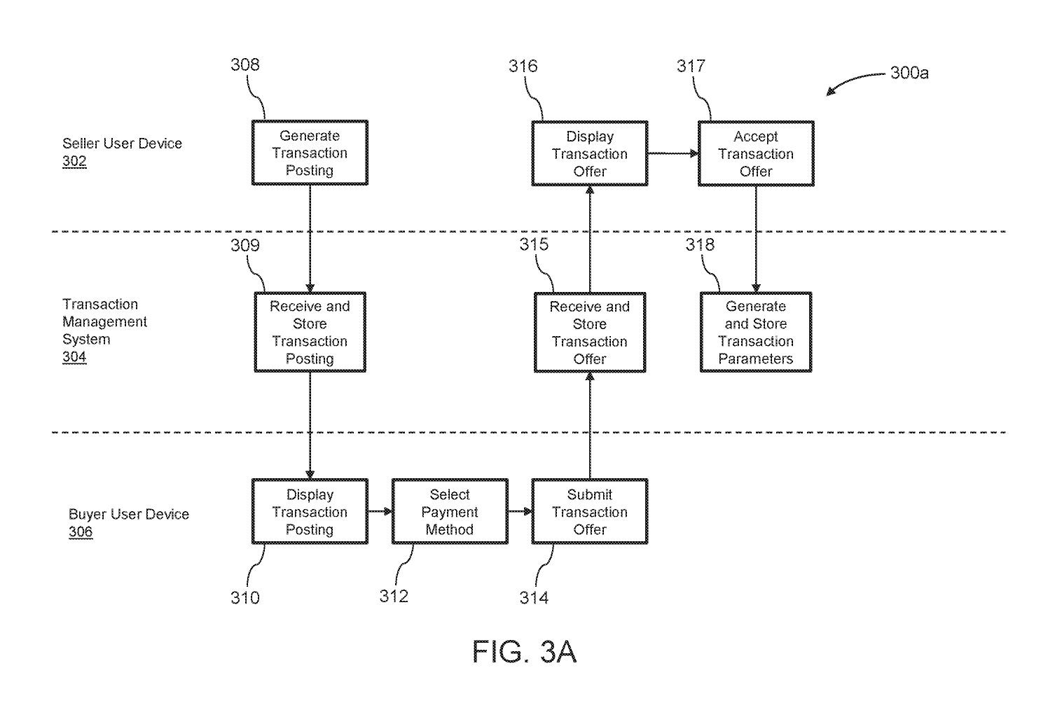

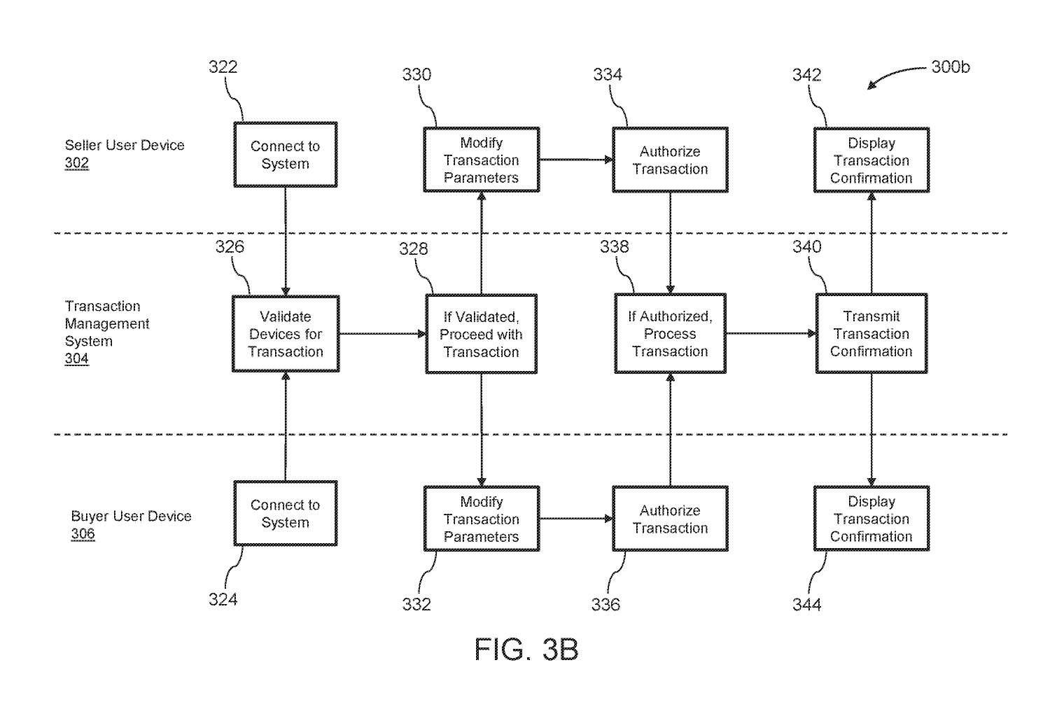

FIGS. 3A and 3B illustrate a processing flow for a server-based method for computer-based local transactions, in accordance with embodiments. The processing flow can include a first processing flow portion 300a (see FIG. 34) performed prior to conducting the local transaction (e.g., before the buyer and seller have met in person) and a second processing flow portion 300b (see FIG. 3B) performed while the local transaction is being conducted (e.g., when the buyer and seller are meeting in person). The various steps of the processing flow can be performed by one or more user devices associated with a seller (e.g., seller user device 302), one or more user devices associated with a buyer (e.g., buyer user device 306), and/or a transaction management system 304, as indicated by the respective regions in FIGS. 3A and 3B separated by the dashed lines. One or more steps of the processing flow depicted in FIGS. 3A and 3B can be used in combination with any embodiment of the methods described herein, such as the methods 200 or 250. It shall be appreciated that any of the steps depicted herein may be optional, combined with any other step, or substituted for any other step.

Referring to FIG. 3A, in step 308, a transaction posting is generated by the seller user device 302. The transaction posting can include one or more of the following types of data: identification information for the device and/or user that generated the posting, the name of the good being offered for sale, an image of the good, a description of the good (e.g., type of good, condition, location, seller-generated description), timing information indicating when the transaction posting was created, a proposed price for the good, and/or a proposed payment method for the good. In some embodiments, the transaction posting data is received as user input via a displayed user interface on the seller user device 302, and the transaction posting is generated based on the received data. Alternatively or in combination, some or all of the transaction posting data can be generated automatically by the seller user device 302 (e.g., location information is automatically determined and generated). The seller user device 302 may need to be logged into a user account registered with the transaction management system 304 before a transaction posting can be generated. In step 309, the transaction posting is received and stored by the transaction management system 304 (e.g., in a transaction posting database).

In step 310, the transaction posting is displayed on a buyer user device 306, e.g., via a user interface. In some embodiments, the transaction posting is transmitted to the buyer device 306 from the transaction management system 304 in response to a request from the buyer device 306. For example, the buyer device 306 can provide a user interface allowing a user to input a search request for transaction postings (e.g., based on the name of the good, type of good, description, price range, location, posting date, seller name, etc.) and transmit the search request to the transaction management system 304. In response, the transaction management system 304 can search the posting database and return postings that match and/or are relevant to the search request.

In step 312, the buyer user device 306 is used to select a payment method for the displayed transaction. As discussed above and herein, the systems, methods, and devices of the present disclosure are suitable for use with a wide variety of payment methods, including both physical payment methods and electronic payment methods. In some embodiments, different types of payment methods are displayed on the buyer user device 306 for selection, If an electronic payment method is selected, the user may be prompted to input payment information, e.g., credit or debit card information, user account information, etc. In some embodiments, step 312 is optional, such that the user is not required to select any payment method, or may delay selecting the payment method until the transaction is ready to be finalized and processed.

In step 314, the transaction offer is submitted by the buyer device 306. The buyer user device 306 may need to be logged into a user account registered with the transaction management system 304 before a transaction offer can be submitted. The submitted transaction offer can include one or more of: a proposed payment amount for the good, a proposed payment method for the good, a proposed time for conducting the location transaction, a proposed location for conducting the location transaction, and/or identification information for the device and/or user that submitted the transaction offer. In some embodiments, the submitted transaction includes at least a proposed payment amount for the good. The proposed payment amount may be the same as the asking price specified in the transaction posting, or may be different (e.g., higher or lower). In step 315, the transaction offer is received and stored by the transaction management system 304 (e.g., in a transaction offer database).

In step 316, the transaction offer is displayed on the seller user device 302. In some embodiments, the transaction offer is transmitted to the seller device 302 from the transaction management system 304 in response to a request from the seller device 302. For instance, the seller device 302 can transmit a request to transaction management system 304 for all transaction offers that were submitted for a particular transaction posting. In response, the transaction management system 304 can search the offer database and return related transaction offers. The transaction offers can be displayed on a user interface that permits the user to further search and/or filter the offers, e.g., based on proposed payment amount, proposed payment method, etc.

In step 317, a transaction offer is accepted by the seller user device 302, e.g., based on user input received via the user interface. The seller user device 302 (and/or the seller user account associated with the seller user device 302) may only be allowed to accept a single transaction offer at a time. The acceptance can be transmitted to the transaction management system 304, which can in transmit a notification to the buyer user device 306 indicating that the offer has been accepted. In step 318, the transaction management system responds to the acceptance by generating and storing transaction parameters for the accepted local transaction, e.g., in a database of parameters for pending local transactions. Optionally, the generated transaction parameters can be transmitted to and displayed on the seller user device 302 and/or buyer user device 306, e.g., as a confirmation of the pending transaction. As discussed above and herein, the transaction parameters can be generated based on transaction data received from the seller user device 302 and/or buyer user device 306, such as data associated with the transaction posting, transaction offer, and/or acceptance of the transaction offer. Optionally, additional transaction parameters can be specified and/or modified after step 318, e.g., if the buyer and seller decide upon a time and location for conducting the transaction after the transaction offer is accepted.

Referring to FIG. 3B, in steps 322 and 324, the seller user device 302. and buyer user device 306 each connect to the transaction management system 304, e.g., via a network connection. The connecting may indicate a request by the seller user device 302 and buyer user device 306 to proceed with the local transaction. In step 326, the transaction management system 304 validates the seller user device 302 and the buyer user device 306 for the transaction. The validation process may involve verifying that the seller user device 302 and the buyer user device 306 are the same devices that were used to initiate the local transaction as depicted herein in steps 308 through 317 of the flow portion 300a. In such embodiments, it may not be possible for a user to use one device to initiate a local transaction (e.g., perform one or more of the steps in flow portion 300a) and use a different device to conduct the transaction (e.g., perform one or more of the steps in flow portion 300b). Alternatively or in combination, the validation process may involve verifying that the seller user device 302 and the buyer user device 306 are associated with the same user accounts that were used to initiate the local transaction (e.g., used to perform steps 308 through 317). In such embodiments, it may possible for a user to initiate and conduct the local transaction using different devices, as long as the user account is the same for both procedures.

Validation of device and/or user account identity can be performed in various ways. For example, the transaction parameters generated and stored by the transaction management system 304 can include identification information for the device and/or user account. In such embodiments, step 326 can involve detecting whether the identification information of the devices and/or accounts connected to the transaction management system 304 matches the stored identification information. Alternatively or in combination, the validation procedure can be performed based on localization information, as described further herein. The use of such validation procedures can improve the security and reliability of the local transaction process by reducing the risk of spoofing and fraud. In some embodiments, validation is performed automatically by the transaction management system 304 once both devices are connected. The validation can be performed without requiring any user input into the seller user device 302 and/or buyer user device 306. Alternatively, the validation may involve entering user input (e.g., a password or PIN) into the seller user device 302 and/or buyer user device 306, as discussed further herein.

In step 328, if both devices are validated, the transaction management system 304 can permit the transaction to proceed. Optionally, in steps 330 and 332, the seller user device 302 and/or buyer user device 306 can modify one or more of the transaction parameters, respectively, such as by transmitting a request for modification (e.g., of the payment amount and/or payment method) to the transaction management system 304 as discussed herein. In steps 334 and 336, the seller user device 302 and/or buyer user device 306 respectively authorize processing the transaction according to one or more transaction parameters. As described herein, if the transaction parameters were modified (e.g., during steps 334 and/or 336), the seller user device 302 and buyer user device 306 will both authorize the modifications before the transaction can proceed.

In step 338, the transaction management system 304 detects whether both devices authorized the transaction. If authorization was received from both devices, the transaction management system 304 processes the transaction, by communicating with a payment processing system to effect transfer of the authorized payment amount. The payment processing system can respond to the transaction management system to confirm whether the requested transfer was successful. In step 340, the transaction management system 304 transmits a transaction confirmation to the seller user device 302 and buyer user device 306, which can then be displayed on the respective devices in steps 342 and 344, respectively. This can provide immediate confirmation to the seller that the payment was successfully received and that the good can now be transferred to the buyer.

Once the transaction management system 304 detects that the local transaction has been completed (e.g., by transmittal of the transaction confirmation 340), the system 304 can remove the transaction posting from the posting database and automatically decline all pending transaction offers. The transaction management system 304 can optionally request feedback data for the completed transaction from the seller user device 302 and/or buyer user device 306, e.g., a quality rating for the particular seller and/or buyer. The quality rating may be displayed in future transaction postings and offers produced by the seller and/or buyer, thus allowing potential transacting parties to assess their reliability and trustworthiness.

In some embodiments, if the transaction is not completed within a predetermined amount of time, the transaction management system 304 causes the transaction to automatically expire. The predetermined time interval can be at least one week, at least two weeks, at least three weeks, or more since the initial acceptance of the transaction offer. Alternatively or in combination, the transaction may expire if the transaction management system 304 receives an indication from the seller user device 302 and/or buyer user device 306 that the transaction will not be completed. If the transaction expires, the buyer user device 306 may need to reinitiate the local transaction by submitting a new transaction offer.

Reservation Offer

In some embodiments, the payment amount for the good is not transferred from the buyer account until the final transaction parameters have been authorized by both parties. Alternatively, in an optional “reservation offer” approach, the buyer user device can authorize transfer of a proposed payment amount from the buyer account to a reserve account before the transaction is conducted (e.g., before the transacting parties meet). In some embodiments, the processing flow for performing a local transaction using a reservation offer is similar to the processing flow depicted in FIGS. 3A and 3B, but with one or more of the modifications described below.

In step 312, the buyer user device 306 is required to select an electronic payment method and input payment information in order to generate a reservation offer. In step 314, the reservation offer is submitted to the transaction management system 304. The reservation offer includes at least a proposed payment amount and the payment method selected in step 312. The transaction management system 304 receives and stores the reservation offer in step 315, e.g., in a reservation offer database. In step 316, the reservation offer is transmitted to and displayed on the seller user device 302. The reservation offer can be displayed separately from regular transaction offers for the posting, e.g., on a different user interface. Alternatively, the reservation offer can be displayed in conjunction with regular transaction offers, but with some indication that allows the seller to differentiate it from the regular transaction offers. In some embodiments, there is a time limit associated with reservation offers, such that the seller user device 302 only has a certain amount of time to respond to the reservation offer (e.g., within 48 hours) and the reservation offer is automatically declined if the seller user device 302 does not respond.

In step 317, a reservation offer is accepted by the seller user device 302. The seller user device 302 (and/or the seller user account associated with the device 302) may only be allowed to accept a single reservation offer for a transaction posting at a time. The acceptance can be transmitted to the transaction management system 304, which can transmit a notification to the buyer user device 306 indicating that the reservation offer has been accepted. A similar notification can be transmitted to the buyer user device 306 if the seller user device 302 declines the reservation offer.

In step 318, the transaction management system 304 responds to the acceptance by generating and storing transaction parameters for the accepted local transaction, as discussed herein. The transaction parameters can include data indicating that the local transaction is specifically to be conducted using payment from a reserve account, rather than the other payment methods described herein. Additionally, the transaction management system 304 can respond to the acceptance by causing the payment amount specified by the reservation offer to be transferred from a buyer account to the reserve account (e.g., by communicating instructions to a payment processing system). The reserve account can be an account that is associated with the transaction management system 304, and not with the buyer user device 306 or the seller user device 302. Once the payment amount has been successfully transferred, the transaction management system 304 can transmit a notification indicating that the transfer has occurred to the seller user device 302 and/or buyer user device 306.

Subsequently, the local transaction can be conducted similar to the embodiments described herein with respect to FIG. 3B, with the modification that in step 338, the transaction management system 304 processes the transaction by causing transfer of the payment amount from the reserve account to an account associated with the seller user device 302. Optionally, the reservation offer approach can be designed to accommodate modifications to the payment amount that may occur in step 330 and/or 332, e.g., due to ad hoc negotiations between the buyer and seller. For example, if the final payment amount authorized in steps 334 and 336 is less than the payment amount that was initially transferred to the reserve account, the difference can be credited back to the buyer account. Conversely, if the final authorized payment amount is greater than the payment amount in the reserve account, the buyer user device 306 may be prompted to authorize transfer of the difference to the reserve account and/or provide the difference through a different payment method.

Alternatively, the payment amount can be transferred back to the buyer account if the transaction management system 304 determines that the transaction will not be completed. The determination can be made based on an indication from the seller user device 302 and/or buyer user device 306 that the local transaction will not be completed. Alternatively or in combination, the transaction can automatically expire if a predetermined amount of time has elapsed since the initial acceptance of the reservation offer (e.g., at least one week, at least two weeks, at least three weeks, etc.). In such embodiments, the buyer user device 306 may need to reinitiate the local transaction by submitting a new reservation offer.

A reservation offer can serve as an indication to the seller that the buyer is more firmly committed to completing the local transaction and purchasing the item. Some sellers may preferentially choose to transact with buyers who submit reservation offers, since a reservation offer demonstrates that the buyer is willing and able to advance sufficient funds to complete the transaction. Accordingly, the use of reservation offers may be advantageous in situations where multiple buyers are competing to purchase an offered good.

Proximity-Based Features

In some embodiments, the systems, methods, and devices herein incorporate one or more features based on proximity between a buyer user device and a seller user device. In a computer-based local transaction, proximity between the buyer and seller user devices may indicate that the buyer and seller are in physical proximity to each other and are ready to conduct the transaction. Accordingly, various embodiments herein implement methods for determining whether a buyer user device and seller user device are in proximity to each other, and automatically performing one or more functions in response to the determination. The proximity-based features described herein can improve security and reliability by providing additional transaction validation, while also enhancing user convenience.

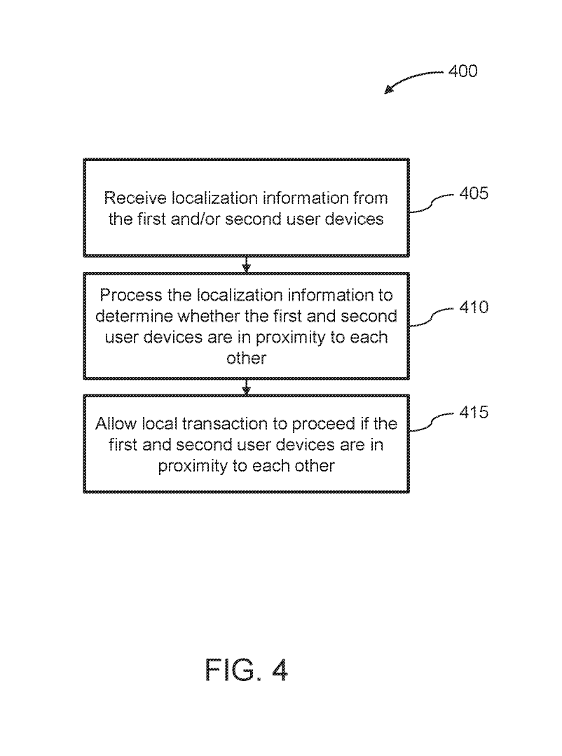

FIG. 4 illustrates a method 400 for proximity detection using a transaction management system, in accordance with embodiments. Similar to other embodiments herein, the steps of the method 400 can be performed by one or more processors of a transaction management system for mediating a local transaction between first and second user devices. In some embodiments, the method 400 is performed after a local transaction has been initiated as described herein. For instance, one or more steps of the method 400 can be performed after step 210 of the method 200 and/or before step 215 of the method 200. Alternatively or in combination, one or more steps of the method 400 can be performed as part of or as a substitute for a validation process performed by the transaction management system when a local transaction is being conducted, e.g., as part of or as a substitute for steps 326 and 328 of the processing flow presented in FIGS. 3A and 3B.

In step 405, localization information is received from the first and/or second user devices. Localization information can include any data related to the location of a user device, including global location data (e.g., relative to a global reference frame or coordinate system) and/or relative location data (e.g., relative to the location of the another user device). In some embodiments, localization information includes one or more of: global positioning system (GPS) data or other position data, Wi-Fi-based positioning system (WPS) data or other wireless access point data, IP address data, Bluetooth® data, near field communication data, and/or GSM triangulation data or other data based on cell tower triangulation. Optionally, the localization information can include a signal indicating that the first and second user devices are in communication with each other over a short range communication link, such as Bluetooth® communication or near field communication. In such embodiments, it may be sufficient to receive the localization information from a single user device rather than both user devices. The localization information can further include a time stamp or other temporal data indicating the time at which the localization information was generated and/or received.

In step 410, the localization information is processed to determine whether the first and second user devices are in proximity to each other. For instance, localization information received from the first user device can be processed to determine a location of the first user device and localization information received from the second user device can be processed to determine a location of the second user device. The locations of the first and second user devices can then be compared to each other to determine proximity. As another example, localization information indicating that the first and second user devices are in communication with each other via a short range communication link may be sufficient to establish that the devices are in proximity to each other.

In some embodiments, the first and second user devices are considered to be in proximity to each other when they are within a target distance of each other. In some embodiments, the target distance is less than about 5 feet, less than about 10 feet, less than about 15 feet, less than about 20 feet, less than about 50 feet, or less than about 100 feet. The target distance can be within a range from about 5 feet to about 25 feet. The target distance may be a fixed value. Alternatively, the target distance may vary, e.g., based on the expected accuracy of the localization information, the expected number of other individuals and/or devices at the transaction location, and/or the initial distance between the first and second user devices (e.g., at the time the transaction was initiated). In such embodiments, the target distance can be determined based one or more of: the localization information type, the expected population density at the location where the local transaction is to be conducted, the number of other user devices at the location, or a distance between the first and second user devices when the transaction was initiated (e.g., when transaction data such as a transaction posting or transaction offer was received). The use of a variable target distance may be advantageous in terms of improving the reliability and accuracy of proximity detection while reducing the rate of false positives.

In step 415, the local transaction is allowed to proceed if the first and second user devices are in proximity to each other. For instance, if the transaction management system determines that the first and second user devices are in proximity, the system can then proceed to step 215 of the method 200 to detect authorization from the first and second user devices. In some embodiments, the proximity detection is part of the validation performed by the transaction management system (e.g., in step 326), such that the transaction is not allowed to proceed if the devices are not in proximity. This may be beneficial for reducing the incidence of fraud in computer-based local transactions. As another example, certain behaviors can be automatically triggered when the first and second user devices are in proximity to each other. In some embodiments, when proximity is detected, the user devices automatically display a user interface prompting the buyer and/or seller to indicate whether they are ready to proceed with the transaction. Optionally, the proximity-based behaviors presented herein can include displaying alerts (e.g., visual, audio, haptic, etc.) via the first and second user devices to notify one party that the other party has arrived, at the transaction location and/or is within a certain distance. In some embodiments, when proximity is detected, the user devices automatically display a user interface mapping the locations of the two devices relative to each other (e.g., a “radar”-type map) so as to facilitate the transaction parties finding each other.

As discussed above and herein, the transaction parameters previously generated and stored by be transaction management system (e.g., during step 210 of the method 200, which may be performed prior to the method 400) can include a location and/or time where the transaction is to be conducted. In such embodiments, the method 400 can optionally involve comparing the localization information to the stored transaction parameters to determine whether the first and second user devices are in proximity at the location and/or time specified by the stored parameters, and allowing the transaction to proceed as described herein if the first and second user devices are in proximity at the specified location and/or time. This approach can reduce false positives that may occur if the buyer and seller happen to encounter each other at a different location and/or time, for reasons unrelated to the transaction. Additionally, these steps can be implemented as part of or as a substitute for a validation process performed by the transaction management system when a local transaction is being conducted, e.g., as part of or as a substitute for steps 326 and 328 of the processing flow presented in FIGS. 3A and 3B. In such embodiments, the transaction may not be allowed to proceed if the user devices are not in proximity at the specified location and/or time. The use of such location and/or time-based validation can further improve transaction security and reliability.

Client-Based Implementation for Computer-Based Local Transactions

In some embodiments, the present disclosure provides client-based implementations and methods for performing computer-based local transactions using user devices. The client-based implementation may also be referred to as a peer-to-peer implementation (P2P). In such embodiments, some or all of the steps of the transaction can be performed by the user devices independently of the transaction management system. For instance, some or all of the steps of the transaction can be performed without one or more both devices being connected to the transaction management system. Accordingly, the user devices may be responsible for mediating certain key steps in the local transaction process, such as performing validation, checking for authorization, and/or processing the transaction. This client-based approach may be advantageous in situations where connectivity to the transaction management systems is unreliable or unavailable, e.g., when the buyer and seller are meeting in a location with poor Internet connectivity.

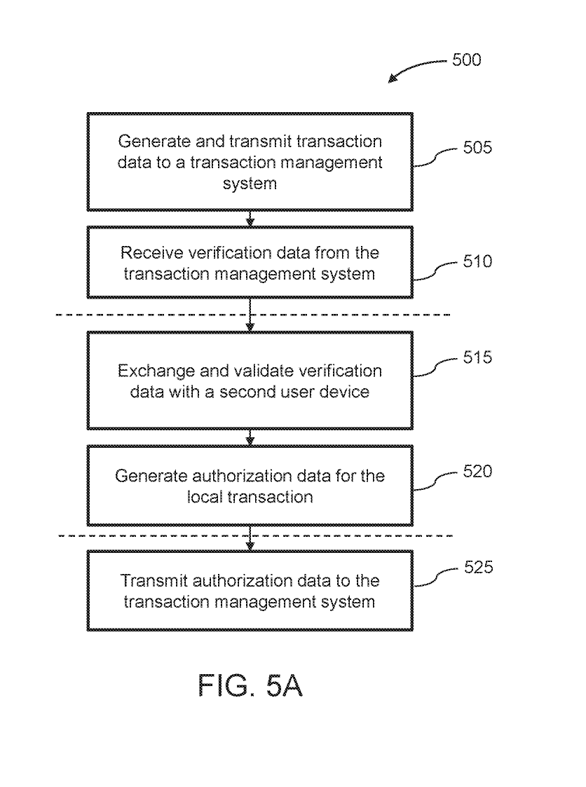

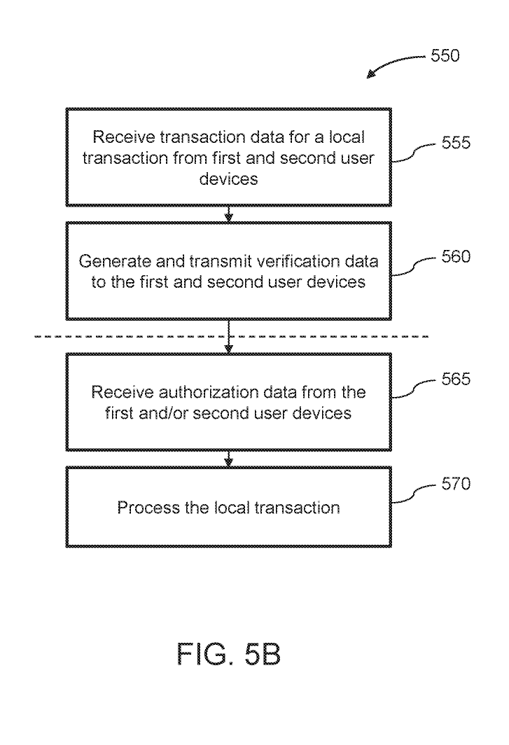

FIG. 5A illustrates a client-based method 500 for computer-based local transactions performed by a user device, in accordance with embodiments. The steps of the method 500 can be performed by one or more processors of a first user device involved in a computer-based local transaction. The user device can be in communication with a transaction management system and/or a second user device. In some embodiments, one or more steps of the method 500 are performed while the user device is not in communication with the transaction management system. For example, as indicated by the dashed lines, steps 505, 510, and 525 may be performed when the user device is communicably coupled to the transaction management system, while steps 515 and 520 may be performed when the user device is not communicably coupled to the transaction management system. In some embodiments, all of the steps of the method 500 are performed using a single user device. Alternatively, some or all of the steps of the method 500 can be performed using a plurality of different user devices (e.g., a plurality of user devices associated with the same user account).

In step 505, transaction data for a local transaction is generated and transmitted to a transaction management system. Step 505 may be performed similarly to steps 255 and 260 of the method 250 previously described herein.

In step 510, verification data is received from the transaction management system. The verification data can be any data that can be exchanged between the first and second user devices in order to allow the devices to validate each other (e.g., verify that the device identity is collect) and/or the transaction (e.g., verify that the transaction is occurring at the expected time, location, etc.). The verification data can be specific to the particular transaction to be conducted and/or the user devices involved in the transaction. Verification data can include one or mare of digital tokens, digital keys, digital signatures, security codes (e.g., PINs), and the like. For example, the verification data can include one or more digital tokens configured with instructions to permit the user devices to conduct the transaction in response to the devices exchanging and validating their respective digital tokens with each other. Various types of digital tokens are suitable for incorporation in the embodiments herein, such as “smart” software tokens configured with instructions to perform functions such as encryption, decryption, validation, etc., as well as other token-based approaches known to one of ordinary skill in the art, In some embodiments, a token system is implemented in conjunction with a third-party system (e.g., Apple Pay®, Touch ID®, etc.), in order to integrate with existing universal token issuers and/or systems. This approach can be beneficial in terms of facilitating transactions with multiple different types of devices.

As another example, the verification data can include one or more security codes configured to permit the user devices to conduct the transaction in response to the devices exchanging and validating their respective security codes with each other. The verification data can be uniquely generated and/or encrypted such that it would be relatively difficult to replicate, mimic, or guess the verification data, in accordance with methods known to one of ordinary skill in the art. Optionally, to further improve security, the verification data can be configured to expire after a predetermined amount of time if not successfully validated in a transaction. The use of verification data enables client-based validation performed by the user devices independently of the transaction management system, as discussed further herein.

In some embodiments, the verification data includes and/or implements one or more transaction requirements that need to be fulfilled before the transaction is permitted to proceed and/or can be authorized. For instance, the transaction requirement can specify that the transaction must be performed at a predetermined time and/or location. As another example, the transaction requirement can limit the modifications that can be made to the transaction parameters, e.g., the payment amount for the transaction must be within a predetermined range, greater than a predetermined minimum value, and/or less than a predetermined maximum value. Exemplary transaction requirements can include one or more of the following: the user devices being in proximity to each other, the local transaction occurring at a predetermined location, the local transaction occurring at a predetermined time, a maximum payment amount for the local transaction, or a minimum payment amount for the local transaction. Accordingly, the validation procedure can further involve verifying that the transaction requirements have been met, as discussed further herein.

In step 515, verification data is exchanged and validated with a second user device. Exchanging verification data can involve transmitting the verification data received in step 510 to the second user device, and receiving verification data into the second user device. In some embodiments, transmission of the verification data is performed by manually inputting the verification into the user device. For example, the buyer can input a buyer security code into the seller user device and/or the seller can input a seller security code into the buyer user device. In other embodiments, transmission of the verification data is performed by the devices using direct communication methods (e.g., Bluetooth®, near field communication), such that no user input is needed. For instance, the user device can automatically transmit one or more digital tokens to the second user device, and vice-versa.

The verification data received from the second user device can then be validated by the first user device. Validation of verification data such as digital tokens, security codes, etc. can be performed in accordance with methods known to one of ordinary skill in the art. In some embodiments, the user device is configured to perform the validation independently of the transaction management system, such that the user device can be configured to perform the validation even when the user device is not connected to the transaction management system (e.g., is offline). Successful validation of the verification data can indicate that the identity of the other user device and/or a user account associated with the other user device is valid, and/or matches the user device and/or user account used to initiate the transaction.

Optionally, the validation procedure can involve confirming that one or more transaction requirements specified by the verification data have been fulfilled. For example, the user device can determine its current location and/or the current location of the second user device (e.g., using localization information as discussed herein), then verify whether the user devices are both at the predetermined location for the transaction specified by the transaction requirement. Similarly, the user device can determine and compare the current time to a predetermined transaction time specified by the transaction requirement. In some embodiments, the transaction requirement may require that the two user devices are in proximity to each other (e.g., within a target distance of each other) before the transaction can be performed. The user device can determine its proximity to the second user device in accordance with the localization methods discussed herein. Alternatively or in combination, the digital tokens described herein can be configured with instructions for performing validation of the transaction requirements.

If the user device successfully validates the verification data from the second user device and vice-versa, the user devices are permitted to conduct the local transaction. As described herein, conducting the local transaction can involve modifying one or more transaction parameters (e.g., payment amount, payment method). The modifications can be communicated directly between the user devices, without requiring interaction with the transaction management system. Optionally, the modifications may be required to conform to one or more transaction requirements specified by the verification data. Conducting the local transaction can also involve transmitting an authorization to the second user device indicative of an approval to perform the local transaction according to one or more transaction parameters, as well as receiving a corresponding authorization from the second user device. Once the authorizations have been mutually transmitted and received, the buyer and seller can be prompted (e.g., via a message displayed on a user interface of the user device) to finalize the transaction by transferring the good to the buyer.

In some embodiments, the user device and/or second user device are configured to communicate with a payment processing system to authorize processing of the transaction and transfer of payment to the seller. Accordingly, the local transaction may be completed by the user device and/or second user device without further involvement from the transaction management system, such that steps 520 and 525 are optional. In other embodiments, however, the user device and/or second user device may not be configured to communicate with the payment processing system to cause payment transfer. In such embodiments, it may be necessary for the user device and/or second user device to notify the transaction management system that the local transaction has been conducted, so that the transaction management system can then communicate with the payment processing system to process and complete the local transaction.

Accordingly, in step 520, authorization data for the local transaction is generated by the user device. The authorization data can be generated in response to a determination that both the user device and the second user device have authorized conducting the transaction according to one or more transaction parameters. Such a determination can be made, for example, based on whether the user device has transmitted an authorization to the second user device and received a corresponding authorization from the second user device. The authorization data can include a digital key, digital token, digital security, security code, or the like that serves as an indication that both parties have authorized the transaction. The authorization data can be uniquely generated and/or encrypted such that it would be relatively difficult to replicate, mimic, or guess the authorization data, in accordance with methods known to one of ordinary skill in the art.

In step 525, the authorization data is transmitted to the transaction management system. The authorization data may be transmitted automatically once the user device connects to the transaction management system, without involving any input from the user. The transaction management system can respond to the authorization data by processing the local transaction to transfer payment to the seller, as discussed further herein. In such embodiments, the buyer and seller may have already exchanged the good prior to step 525, such that the seller is not actually paid until a later time when the user device is able to connect to the transaction management system.

The timing of the steps of the method 500 may be related to the stage of the local transaction. In some embodiments, as indicated by the dashed line, steps 505 and 510 are performed before the local transaction has been conducted (e.g., before the buyer and seller have met in person to conduct the transaction) and steps 515 and 520 are performed when the local transaction is being conducted (e.g., during the in-person meeting between the buyer and seller). Step 525 may be performed during the local transaction or after the local transaction has been conducted (e.g., after the in-person meeting). The user device can be configured to determine the current stage of the local transaction and automatically proceed to the appropriate step. For instance, the user device can receive user input indicating that the transaction is being conducted (e.g., user input indicating that the buyer is with the seller and is ready to proceed) and automatically proceed to step 515. Optionally, the user device can use other methods besides user input to detect whether the transaction is being conducted, such as using localization information to determine whether the user device is in proximity to the second user device. In alternative embodiments, the method 500 can be performed without considering the stage of the local transaction.

FIG. 5B illustrates a client-based method 560 for computer-based local transactions performed by a transaction management system, in accordance with embodiments. The steps of the method 560 can be performed by one or more processors of a transaction management system in communication with two transacting user devices.

In step 555, transaction data for a local transaction is received from first and/or second user devices. Step 555 may be performed similarly to the step 205 of the method 200 previously described herein.

In step 560, verification data is generated and transmitted to the first and second user devices. The verification data generated by the transaction management system can be similar to the data previously described, herein with respect to step 510 of the method 500. Generation of verification data such as digital tokens, digital keys, security codes, etc. can be performed in accordance with methods known to one of ordinary skill in the art. For example, the verification data can include one or more digital tokens configured with instructions to permit the first and second user devices to conduct the local transaction in response to the first and second user devices exchanging and validating their respective digital tokens with each other. The digital tokens can be configured to permit the first and second user devices to conduct the local transaction independently of the transaction management system when both devices have received the digital tokens. In some embodiments, the digital tokens are configured to permit the first and second user devices to conduct the local transaction without being connected to the transaction management system when both devices have received the digital tokens. Alternatively or in combination, the verification data can include one or more security codes configured to permit the first and second user devices to conduct the local transaction in response to the devices exchanging and validating their respective security codes with each other.

In some embodiments, the verification data transmitted to each device is customized for that particular device, such that the data transmitted to the first and second user devices is different. The transaction management system can maintain a record of the specific user device that is associated with the verification data. Accordingly, the verification data can serve as a unique identifier for the particular device. In embodiments where the verification data is associated with a device only, this would restrict the local transaction to being performed using that specific device, which may provide greater security. Alternatively, the transaction management system can associate the verification data with a user account rather than a specific user device. In such embodiments where the verification data is associated with a user account, it may be possible for the transaction to be performed with a different device that is associated with the same account, which may provide greater flexibility.

In some embodiments, the verification data can be generated based on one or more transaction parameters (e.g., payment amount, payment method, transaction location, transaction time, etc.) for the local transaction. The transaction parameters may have been previously generated and stored by the transaction management system as discussed herein. In some embodiments, for instance, the transaction parameters can be used to determine one or more transaction requirements for the verification data. Subsequently, the user devices can validate that the local transaction is being conducted in accordance with the previously agreed upon transaction parameters (e.g., a predetermined time, location, payment amount, etc.). This approach can provide an additional layer of security for computer-based. local transactions, as attempts to conduct a local transaction in a manner that is inconsistent with the transaction parameters (e.g., an unexpected time, location, payment amount, etc.) may be indicative of fraudulent activity.

In step 565, authorization data is received from the first and/or second user devices. Receipt of the authorization data can indicate to the transaction management system that the local transaction was successfully conducted and should be processed in order to pay the seller. The transaction management system can process the authorization data to confirm its validity, using methods known to one of ordinary skill in the art. If the authorization is validated, the transaction management system can then proceed to step 570 to process the local transaction, thus effecting transfer of payment to the seller account. Step 570 may be performed. similarly to the step 220 of the method 200 previously described herein.

In some embodiments, authorization data is received from both user devices before the transaction management system can process the transaction. Alternatively, authorization data received from a single user device may be sufficient to permit the transaction management system to proceed. In such embodiments, as long as one of the two user devices connects to the transaction management system after the local transaction has been conducted, the transaction management system can determine that the transaction did occur and process payment accordingly. This approach can be used to prevent unscrupulous buyers from delaying payment by disconnecting the buyer user device, since the payment can be triggered by authorization data from the seller user device alone.

The timing of the steps of the method 550 may be related to the stage of the local transaction. In some embodiments, as indicated by the dashed line, steps 555 and 560 are performed before the local transaction has been conducted, while steps 565 and 570 are performed during the local transaction or after the local transaction has been conducted (e.g., after the in-person meeting has taken place and/or after the good has already been transferred from buyer to seller).

In such embodiments, one or more steps of the method 550 can be performed in coordination with one or more steps of the method 500. For example, steps 555 and 560 of the method 550 can be performed between steps 505 and 510 of the method 500, and steps 565 and 570 of the method 550 can be performed after step 525 of the method 500.

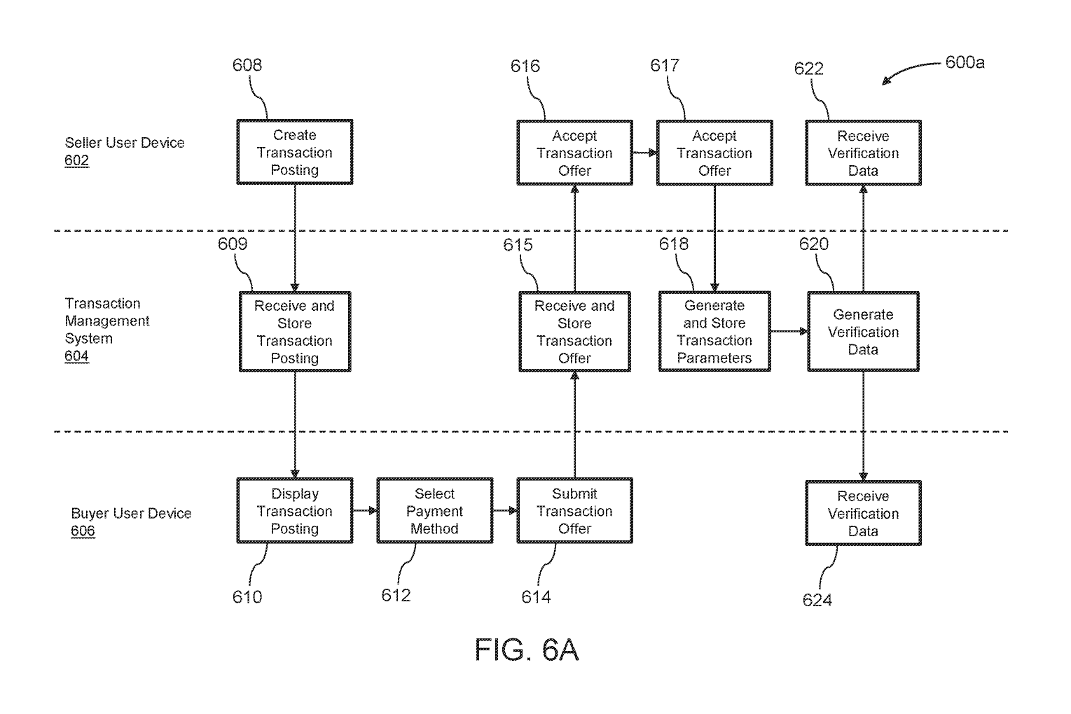

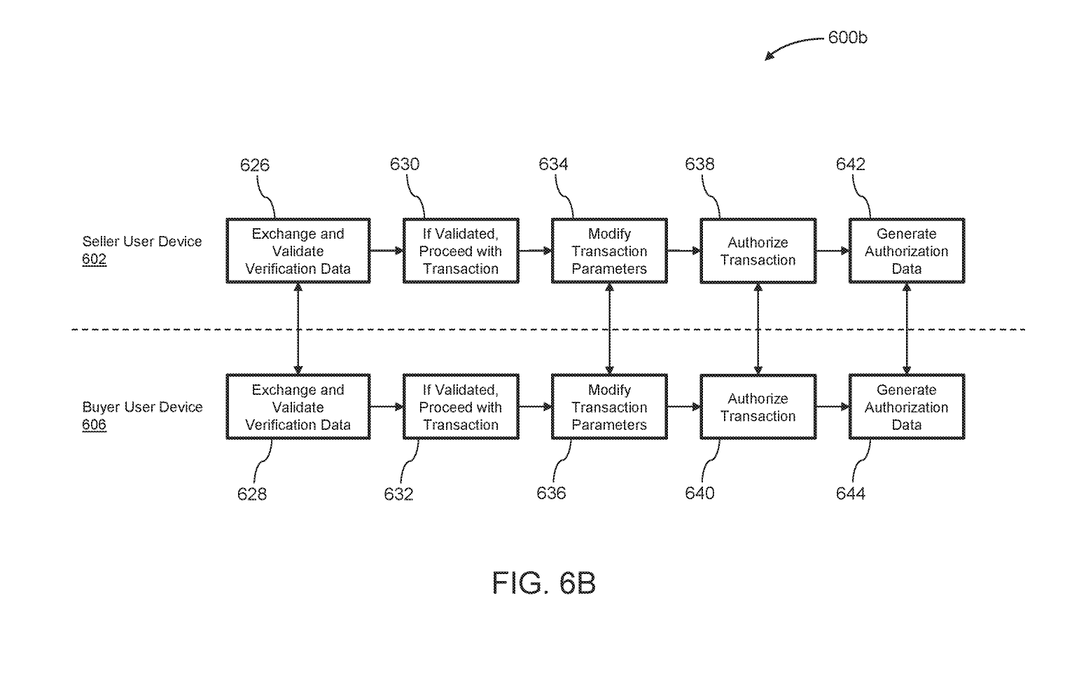

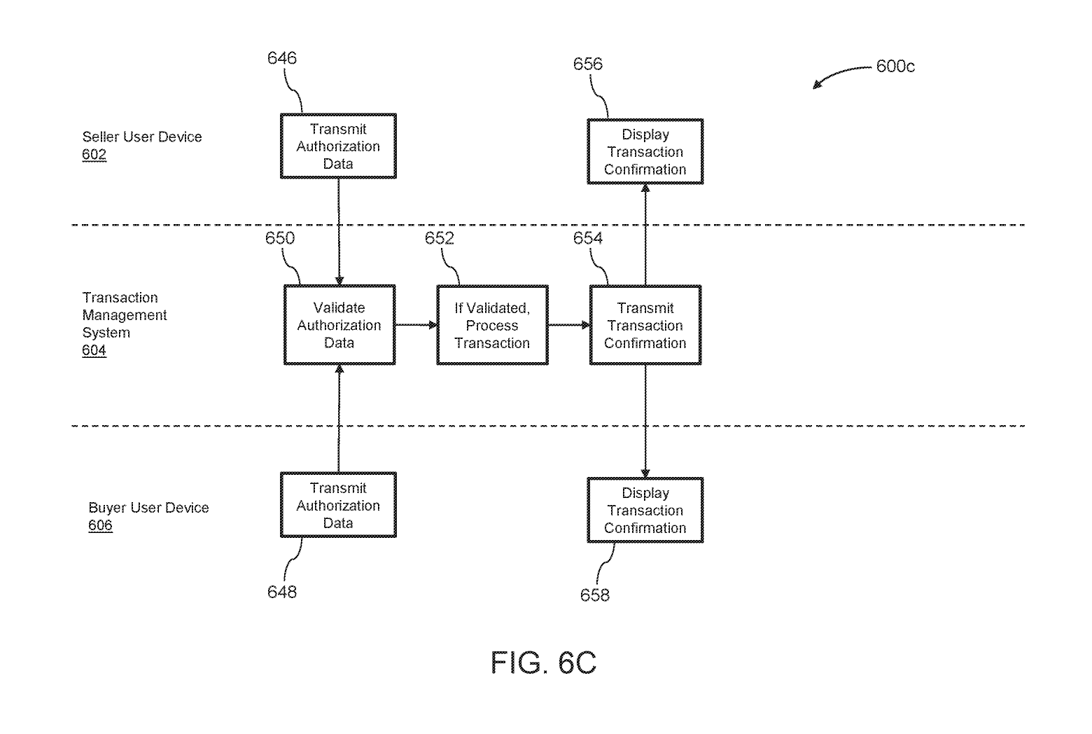

FIGS. 6A through 6C illustrate a processing flow for a client-based method for computer-based local transactions, in accordance with embodiments. The processing flow can include a first processing flow portion 600a (see FIG. 6A) performed prior to conducting the local transaction (e.g., before the buyer and seller have met in person), a second processing flow portion 600b (see FIG. 6B) performed while the local transaction is being conducted (e.g., when the buyer and seller are meeting in person), and a third processing flow portion 600c (see FIG. 6C) performed while the local transaction is being conducted or after the local transaction has been conducted (e.g., after the good has been transferred to the buyer). The various steps of the processing flow can be performed by one or more user devices associated with a seller (e.g., seller user device 602), one or more user devices associated with a buyer (e.g., buyer user device 606), and/or a transaction management system 604, as indicated by the respective regions in FIGS. 6A through 6BC separated by the dashed lines. Some or all of the steps depicted in FIG. 69 can be performed by the seller user device 602 and buyer user device 606 independently from the transaction management system 604. One or more steps of the processing flow depicted in FIGS. 6A through 6C can be used in combination with any embodiment of the methods described herein, such as the methods 500 or 550. It shall be appreciated that any of the steps depicted herein may be optional, combined with any other step, or substituted for any other step.

Referring to FIG. 6A, steps 608 through 618 of the processing flow portion 600a may be performed. similarly to steps 308 through 318 of FIG. 3A previously described herein. In step 620, verification data is generated by the transaction management system 604. The verification data is transmitted to the seller user device 602 and buyer user device 606 in steps 622 and 624, respectively. Once the verification data has been transmitted and received, the seller user device 602 and buyer user device 606 can proceed to conduct the local transaction independently from the transaction management system 604.

Referring to FIG. 6B, in steps 626 and 628, the seller user device 602 and buyer user device 606 directly exchange and validate verification data with each other. As discussed herein, data exchange may or may not involve manual input from a user. In steps 630 and 632, if the verification data is validated, the seller user device 602 and buyer user device 606 can proceed with the local transaction. Optionally, in steps 634 and 636, the seller user device 602 and/or buyer user device 604 can modify one or more of the transaction parameters, respectively. The seller user device 602 and buyer user device 606 may communicate proposed modifications to each other via direct communication. In steps 638 and 640, the seller user device 602 and/or buyer user device 606 respectively authorize processing the transaction according to one or more transaction parameters, via direct communication with each other. As described herein, if the transaction parameters were modified (e.g., during steps 634 and/or 636), the seller user device 602 and buyer user device 606 will need to authorize the modifications before the transaction can proceed. Once both devices have mutually authorized the transaction, authorization data is generated by the seller user device 602 and buyer user device 606 in steps 642 and 644, respectively. The seller user device 602 and buyer user device 606 can exchange authorization data as further confirmation that both parties authorized, the transaction. At this point, the user devices can display a user interface prompting the seller to transfer the good to the buyer. The seller user device 602 and/or buyer user device 606 can subsequently reconnect with the transaction management system 604 in order to effect the actual transfer of the payment amount to the seller, thereby completing the local transaction.

Referring to FIG. 6C, in steps 646 and 648, the seller user device 602 and buyer user device 606 transmit authorization data to the transaction management system 604. In step 650, the transaction management system 604 validates the received authorization data to confirm that the transaction was successfully conducted. One of the steps 646 or 648 may be optional, such that the transaction management system 604 can proceed even if authorization data is received from only one of the user devices. Once validation has been successfully performed, the transaction management system can proceed to process the transaction in step 652 by communicating with a payment processing system. The steps 652 through 658 can be performed similarly to steps 338 through 344 of FIG. 3D previously described herein.

It shall be understood that the discussion of certain embodiments in the context of client-based implementations is not intended to be limiting, and that any of the steps or components described herein with respect to a client-based implementation are equally applicable to and can be used in combination with any other implementation, such as the server-based implementations presented herein, and vice versa. For example, the reservation offer approach discussed herein can also be used with a client-based implementation. The modifications to the processing flows of FIGS. 6A and 6C to accommodate reservation offers may be similar to the modifications to the processing flows of FIGS. 3A and 3B described above.

Additionally, the client-based implementation can incorporate one or more of the proximity-based features presented herein. In such embodiments, the user devices are configured to determine proximity to each other independently of the transaction management system. For example, a user device can be configured to determine its own location (e.g., using self-generated localization information) and the location of the other user device (e.g., using localization information received from the other device), and can compare the two locations to determine proximity (e.g., whether the two locations are within a target distance). Alternatively or in combination, proximity can be established if the user device successfully communicates with the other user device using a short range communication method. Confirmation of proximity can be used as a basis for allowing the local transaction to proceed and/or triggering certain behaviors, as described herein.

Moreover, the verification data approaches described herein can also be incorporated into a server-based implementation. For example, in some embodiments, the processing flow in FIGS. 3A and 3B can include one or more of the following modifications. Subsequent to step 318, the transaction management system 304 generates verification data and transmits the verification data to the seller user device 302 and buyer user device 306, similar to steps 620 through 624 of FIG. 6A. In step 326, the transaction management system 304 can receive and validate verification data from the seller user device 302 and buyer user device 306. Alternatively, the transaction management system 304 can mediate the exchange of verification data between the seller user device 302 and buyer user device 306, and confirm that validation was successful for both devices. As yet another option, the seller user device 302 and buyer user device 306 can exchange and validate verification data independently of the transaction management system 304, similar to steps 626 and 628 of FIG. 6B. Once the verification data from both devices is successfully validated, the processing flow can then proceed to step 328. Optionally, the authorization of the transaction in steps 334 through 338 can involve mutually transmitting and receiving authorizations between the seller user device 302 and buyer user device 306, similar to steps 638 and 640 of FIG. 6B.

In some embodiments, the systems, methods, and devices for performing computer-based local transactions provided herein can utilize both the server-based implementation and the client-based implementation. For example, the server-based implementation can be used as the default approach for performing the transaction, while the client-based implementation can be used as a failover in case the user devices are unable to communicate with the transaction management system (e.g., if Internet connectivity is lost during the transaction process). In such embodiments, the transaction management system can be configured to generate verification data (e.g., tokens, security codes, etc.) for each transaction, even if the transaction is ultimately performed without using the verification data (e.g., the client-based implementation is not used). As another example, the server-based implementation and the client-based implementation can be used simultaneously, such that validation and/or authorization is performed by the devices as well as the transaction management system. This approach can provide an extra level of security to the transaction process.

In alternative embodiments, the systems, methods and devices herein can be configured for only a single implementation, e.g., the server-based implementation only or the client-based implementation only. Optionally, a method for computer-based local transactions can be implemented as a P2P implementation that is completely independent of the transaction management system. In such embodiments, one or more of the user devices can include a local and/or web application configured with instructions to perform some or all of the functionalities of the transaction management system discussed herein.

User Interface

The various user interface embodiments described herein can be used in combination with any of the systems, methods, and devices of the present disclosure. As discussed above and herein, the systems, devices presented herein can utilize user interfaces to output information to a user and receive input from the user in order to facilitate the transaction process. The user interface can be generated by a software application (e.g., mobile app, web app, etc.) running on the user device. In some embodiments, the user interface is configured to receive user input (e.g., via interactive graphical elements such as buttons, input fields, sliders, toggles, checkboxes, etc.). The user device can transmit signals to the transaction management system and/or another user device in response to the user input. The specific user interfaces that are displayed by the application may vary depending on whether the user device is associated with a buyer or a seller in a particular local transaction, the stage of the transaction (e.g., whether the transaction has been initiated, conducted, or completed), and/or the particular parameters of the transaction (e.g., payment method). In some embodiments, the transaction management system is configured to transmit signals to a user device in order to cause a certain user interface to be displayed. Alternatively or in combination, the user devices can be configured to transmit signals to each other to cause a certain user interface to be displayed.

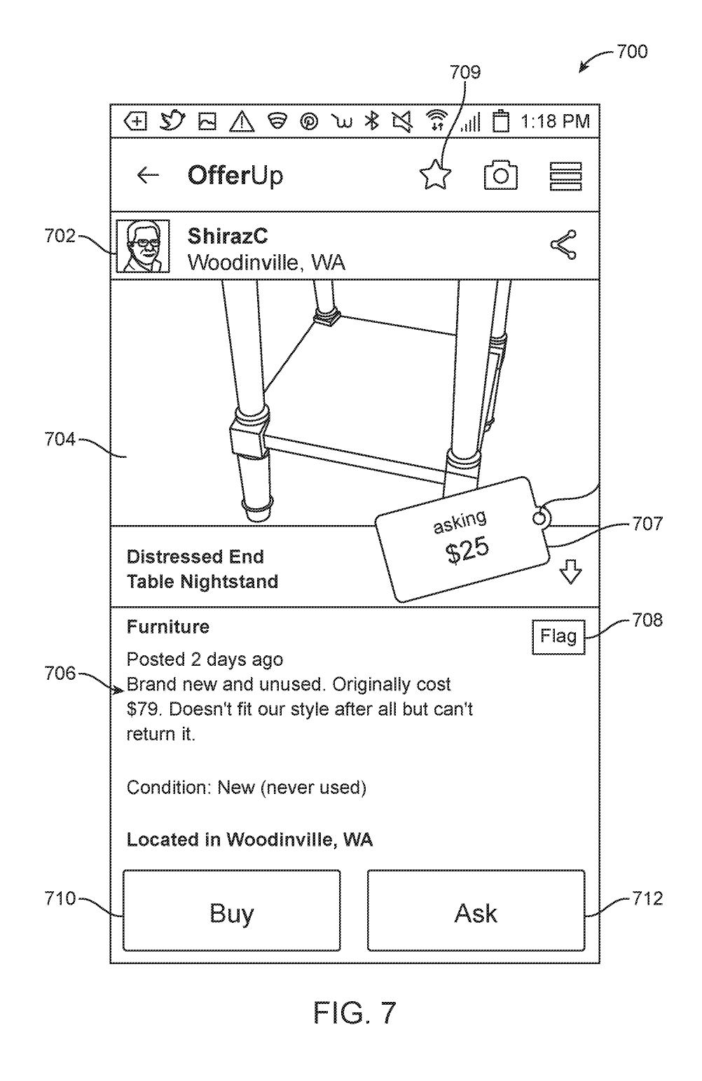

FIG. 7 illustrates a user interface (UI) 700 for displaying a transaction posting, in accordance with embodiments. The UI 700 can be used to display a transaction posting to a potential buyer. In some embodiments, the UI 700 displays seller information 702 for the seller who created the transaction posting (e.g., name, location, an image), the name and/or an image 704 of the good being offered for sale, a description 706 of the good (e.g., type of good, condition, location, seller-generated description, when the transaction posting was created), and the asking price 707 requested by the seller. The UI 700 can also include interactive elements (e.g., buttons, links, etc.) for receiving input from the user. For example, the UI 700 can include a “Flag” button 708 allowing the user to report the transaction posting for moderation or review. The UI 700 can include a “Favorite” button 709 (depicted as a star icon) allowing the user to mark the transaction posting for follow up and/or add the transaction posting to a watch list. The UI 700 can also include a “Buy” button 710 allowing the user to create a transaction offer to purchase the good. Optionally, the UI 700 can include an “Ask” button 712 allowing the user to communicate with the seller, e.g., in order to request more information about the transaction posting.

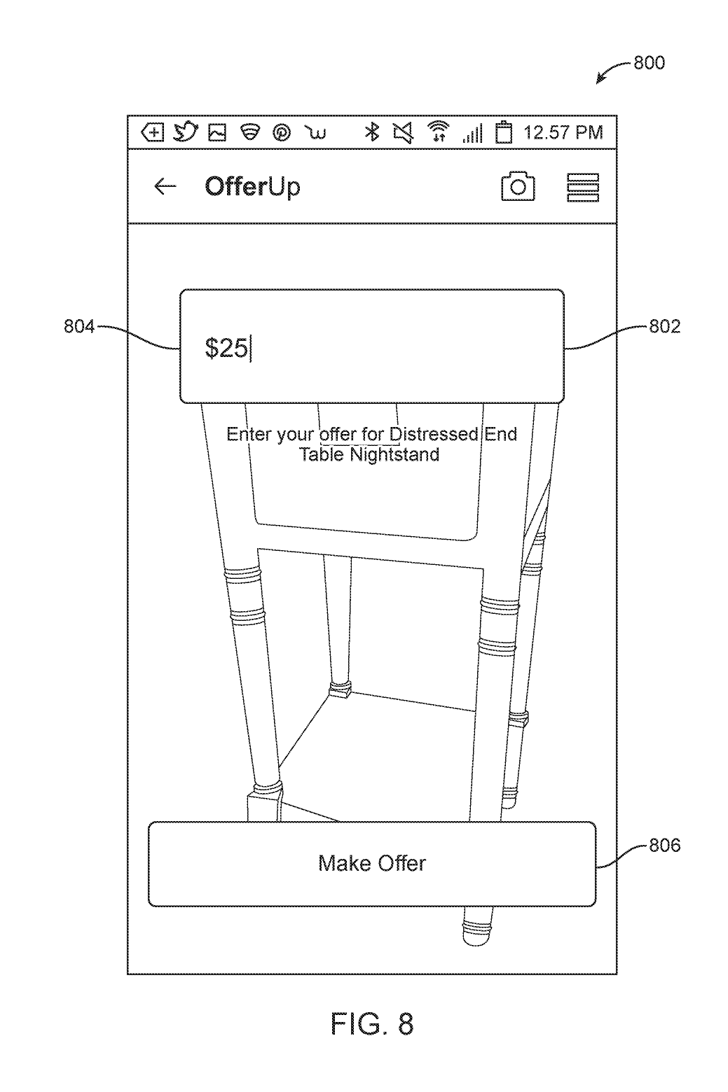

FIG. 8 illustrates a UI 800 for creating and submitting a transaction offer, in accordance with embodiments. The UI 800 can be displayed on a buyer user device in response to the buyer inputting instructions to create a transaction offer to purchase a good (e.g., by selecting the “Buy” button 710 of the UI 700). The UI 800 can include an input field 802 for receiving user input indicating the amount the user is willing to pay for the particular good. In some embodiments, the UI 800 displays the seller's asking price 804 as the default value in the input field 802, and the user has the option of modifying the price if desired. The UI 800 can also include a “Make Offer” button 806 that allows the user to submit the transaction offer to the transaction management system.

In some embodiments, the UI 800 can allow the user to input other parameters for the transaction offer in addition to the payment amount. For example, the UI 800 can include an input field (not shown) for the user to specify a proposed payment method for the transaction (e.g., cash payment, check payment, credit card payment, debit card payment, electronic “cashless” payment, etc.). If the user selects a cashless payment method, the UI 800 may prompt the user to input information enabling the transaction management system to authorize payment via an electronic payment processing system, such as credit or debit card information, e-commerce payment account information, etc. Credit and debit card information can be obtained in various ways, e.g., by having the user manually input the card information, by having the user take a photograph of the card and extracting the information from the image, by having the user select the card from a list of saved cards, etc. In alternative embodiments, the user may be prompted to specify the payment method only after the transaction offer has been submitted. Optionally, the user can proceed without specifying the payment method for the transaction.

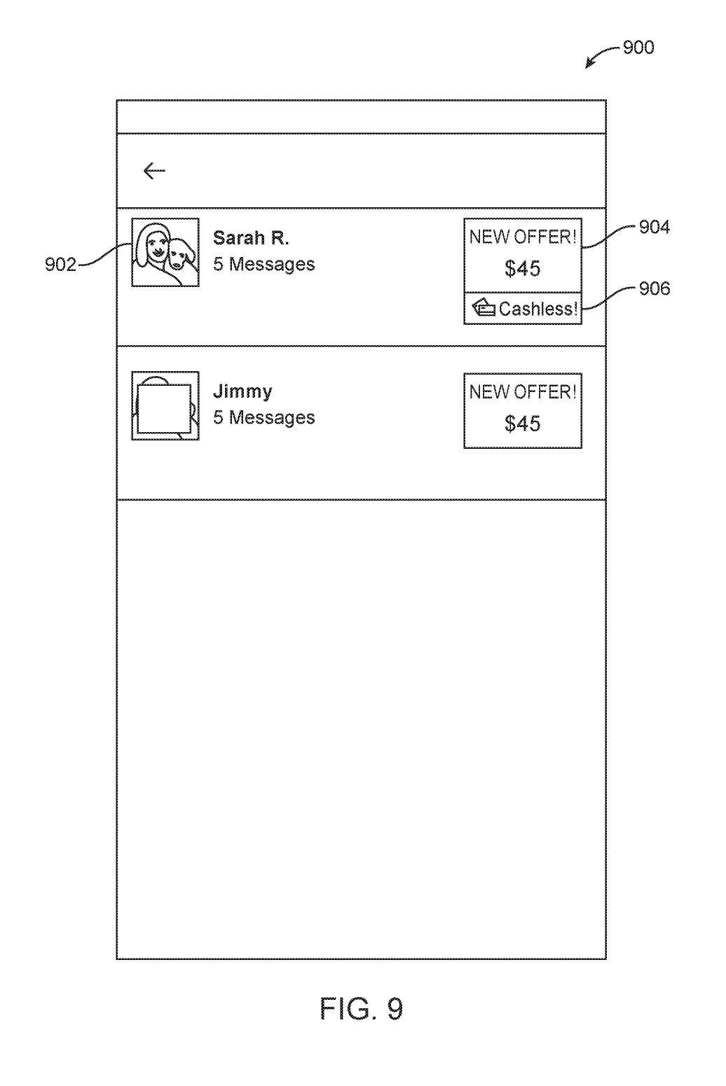

FIG. 9 illustrates a UI 900 for displaying and selecting a transaction offer, in accordance with embodiments. The UI 900 can be provided on the display of a seller user device in order to display received transaction offers. Each displayed offer can include buyer information 902 for the buyer who submitted the offer (e.g., name, location, an image) and the offered payment amount 904. The UI 900 can also indicate whether the buyer has messaged the seller (e.g., to indicate interest, discuss the offer, etc.) and allow the seller to view the messages. Optionally, the UI 900 can also display other parameters for the transaction offer, such as a proposed payment method 906 for the transaction. In such embodiments, the seller can preferentially select an offer that uses a preferred payment method. For example, electronic payment methods may be preferred because they may be more reliable, verifiable, and convenient than physical payment methods.

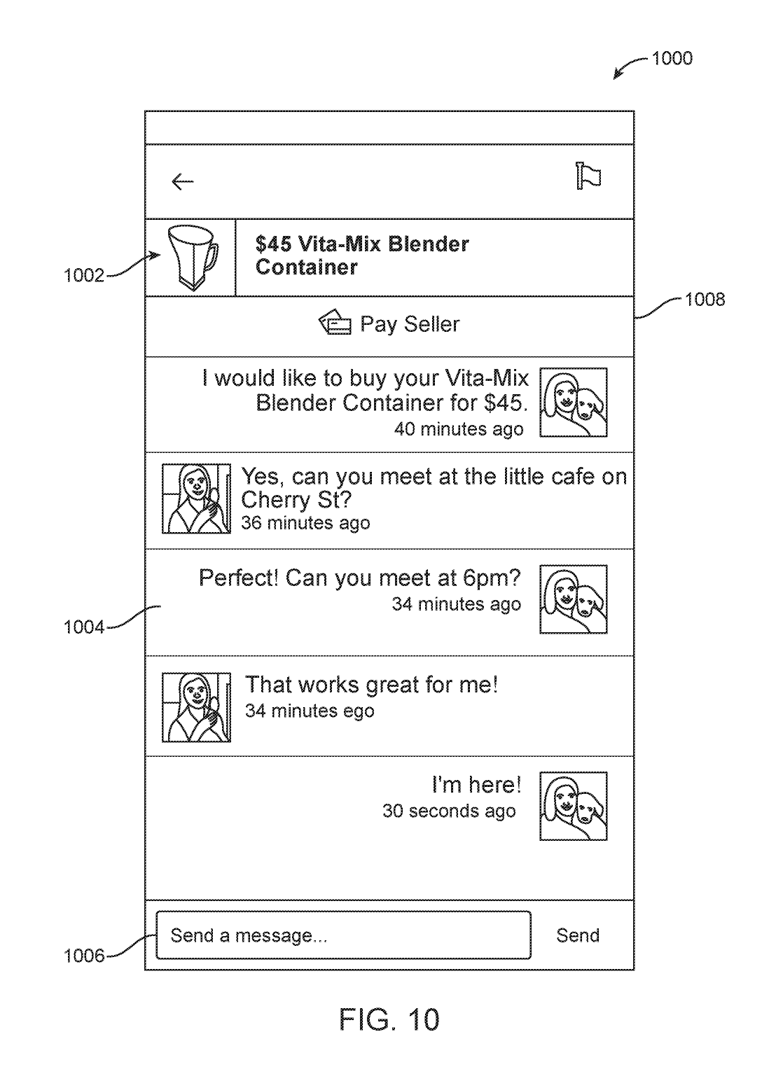

FIG. 10 illustrates a UI 1000 for communicating with a transacting party, in accordance with embodiments. The UI 1000 can allow the user to view the communications between the buyer and seller related to a particular transaction posting 1002. For example, the UI 1000 can include a log 1004 of all previous communications with the other transaction party. Additionally, the UI 1000 can include an input field 1006 allowing the user to create and send a new message. The UI 1000 can provide a simple and convenient mechanism for the buyer and seller to communicate with each other in order to arrange the local transaction, without having to use another application or communication method. Optionally, the UI 1000 can allow the buyer to initiate the process of paying the seller to consummate the local transaction, e.g., via a “Pay Seller” button 1008. For instance, once the buyer has met with the seller to physically inspect the good and approve the transaction, the buyer can proceed to initiate the payment procedure via the UI 1000.

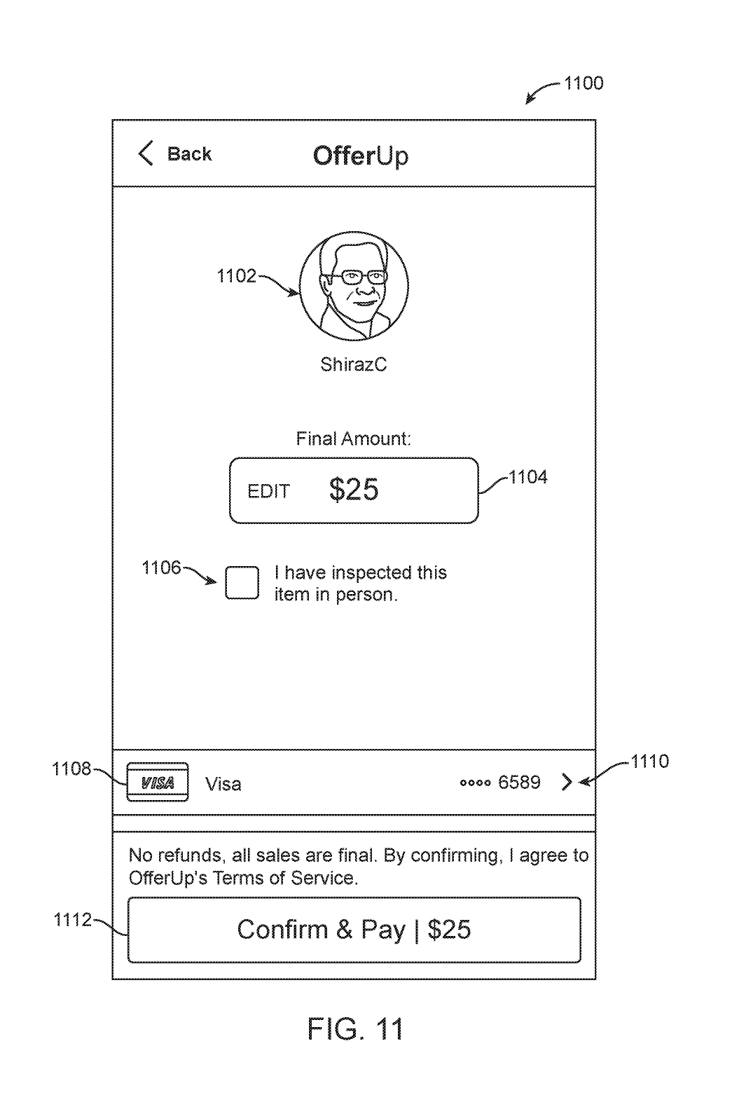

FIG. 11 illustrates a UI 1100 for modifying transaction parameters, in accordance with embodiments. The UI 1100 can be displayed on a buyer user device once the buyer has met in person with the seller to conduct the local transaction. For instance, the UI 1100 can be displayed in response to the buyer inputting instructions to conduct the transaction (e.g., by selecting the “Pay Seller” button 1008 in the UI 1000). Alternatively or in combination, the UI 1100 can be automatically displayed in response to a determination that the buyer user device and seller user device are in proximity to each other, as discussed herein. Optionally, the UI 1100 is displayed only if both devices have been successfully validated for the transaction, e.g., by the transaction management system and/or by each other. The UI 1100 can be used to display various transaction parameters for the local transaction, such as seller information 1102, a payment amount 1104, the name of the good, payment method 1108, and/or whether the buyer has inspected the good in person (e.g., as indicated by user input received via an input element such as checkbox 1106).

In some embodiments, the displayed transaction parameters are the initial parameters generated and stored by the transaction management system, e.g., when the transaction offer was accepted. For example, the displayed payment amount 1104 and payment method 1108 may reflect the payment amount and method specified by the buyer and accepted by the seller in the initial transaction offer. As discussed above and herein, it may be desirable in some embodiments to permit the buyer and/or seller to modify one or more of these parameters during the local transaction, e.g., in response to in-person negotiations between the buyer and seller. Accordingly, the UI 1100 can be configured to receive user input modifying various transaction parameters. In the depiction of FIG. 11, the UI 1100 includes a modifiable input field for adjusting the payment amount 1104 and a link 110 for modifying the payment method. Once the appropriate modifications have been made, the buyer can submit the modification request to the transaction management system and/or seller user device by selecting a “Confirm & Pay” button 1112. The seller user device can then display the proposed modifications so that the seller can decide whether to accept or reject the transaction with the modified parameters.

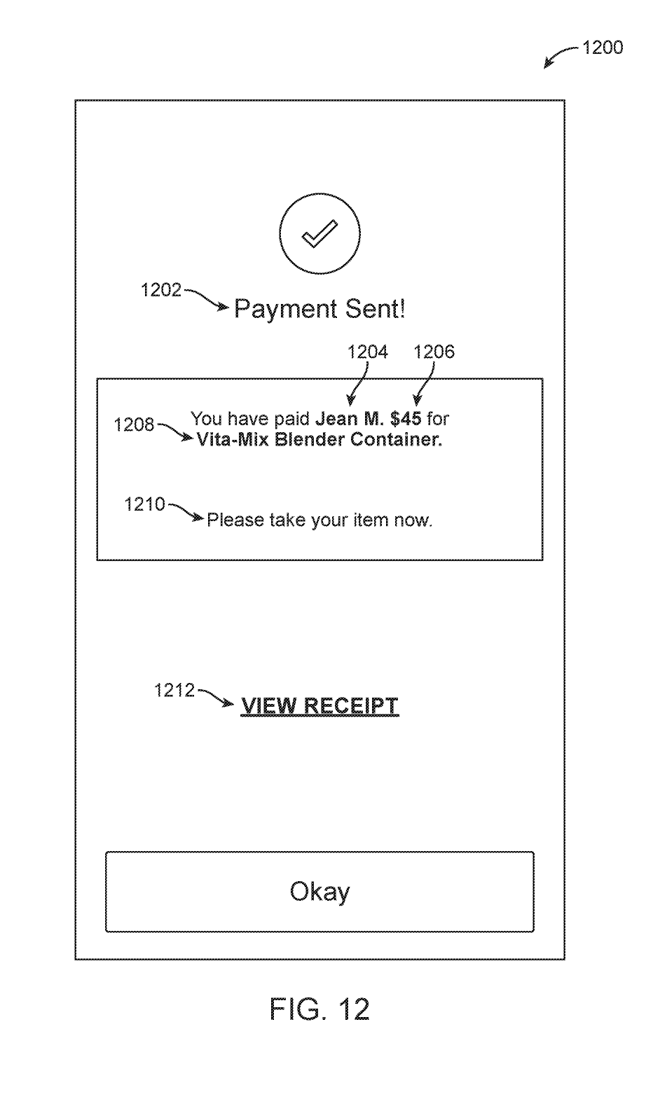

FIG. 12 illustrates a UI 1200 for displaying a transaction confirmation, in accordance with embodiments. In the server-based implementations described herein, the UI 1200 can be displayed once the transaction management has determined that both devices have authorized the local transaction and/or has received confirmation the local transaction was successfully processed. In the client-based implementations described herein, the UI 1200 can he displayed once both devices have authorized the transaction and communicated this authorization to each other. The UI 1200 can include a notification 1202 that payment was successfully transferred to the seller, seller information 1204, the payment amount 1206, the name of the good being paid for 1208, and/or a message 1210 indicating that the good can now be transferred from buyer to seller. Additionally, the UI 1200 can include a link 1212 or other selectable element that allows the user to view a receipt for the transaction. The UI 1200 can be displayed on a buyer user device to confirm that the transaction was successfully completed. A similar transaction confirmation UI can be displayed on a seller user device to confirm that the seller has been paid and can proceed to transfer the good to the buyer.

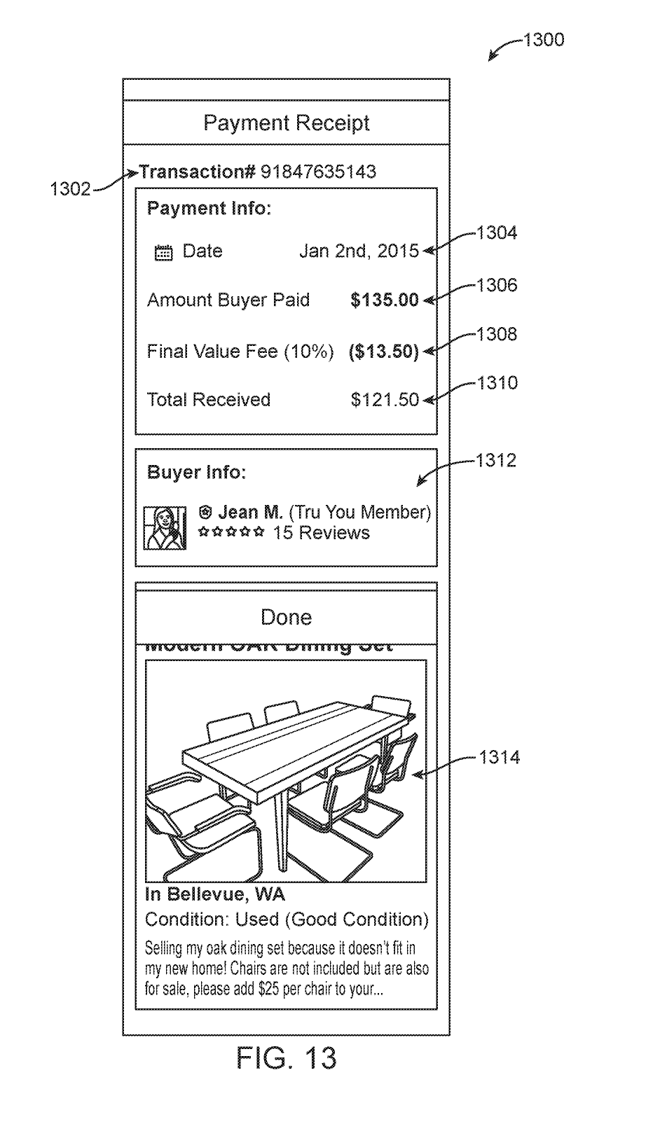

FIG. 13 illustrates a UI 1300 for displaying a transaction receipt, in accordance with embodiments. The UI 1300 can be displayed on the buyer and/or seller user devices to allow the buyer and/or seller to view the final transaction parameters. The displayed receipt can include a transaction identifier 1302, the transaction date 1304, the amount the buyer paid for the good 1306, any additional processing fees 1308, the total received by the seller 1310, information for the buyer and/or seller 1312, and/or information for the good that was transacted 1314. The transaction receipt can serve as a record of the local transaction, which may be beneficial in terms of reducing the incidence of scams or fraud.

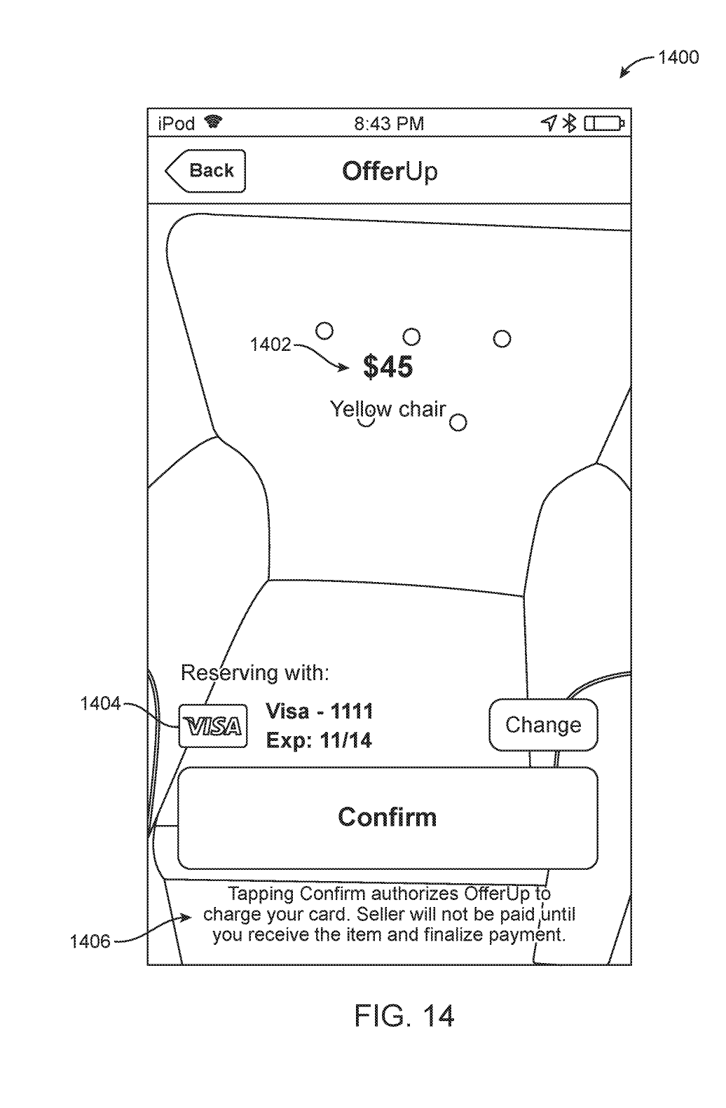

FIG. 14 illustrates a UI 1400 for submitting a reservation offer, in accordance with embodiments. The UI 1400 can be displayed on a buyer user device in response to user input indicating that the buyer wishes to create a reservation offer instead of a regular transaction offer. As discussed above and herein, a reservation offer indicates a commitment from a buyer to transfer the offered payment amount to a reserve account if the offer is accepted by the seller. The UI 1400 can include an input field 1402 indicating the proposed payment amount and an input field 1404 indicating the electronic payment method to be used. The UI 1400 can also include a notification 1406 alerting the buyer that the payment amount will be transferred to a reserve account if the reservation offer is accepted.

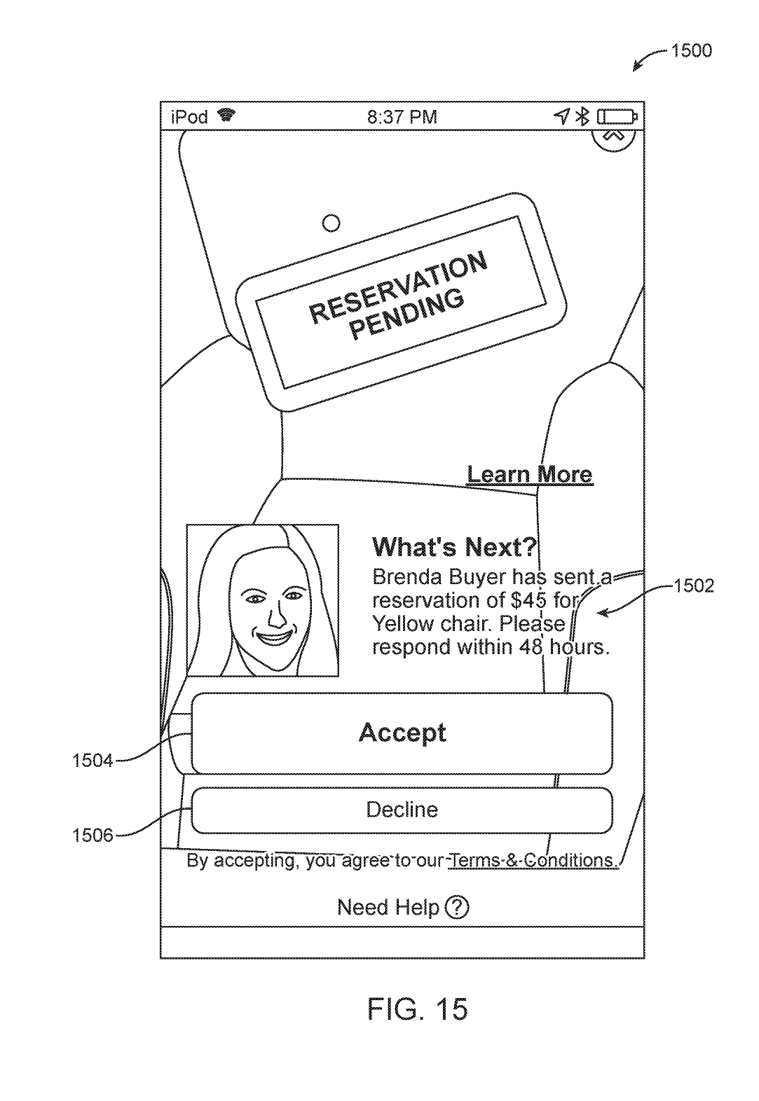

FIG. 15 illustrates a UI 1500 for displaying and approving a reservation offer, in accordance with embodiments. The UI 1500 can include the transaction data 1502 associated with the reservation offer (e.g., buyer information, proposed payment amount, etc.). The UI 1500 can also include interactive elements for receiving user input to accept the reservation offer (e.g., “Accept” button 1504) or decline the reservation offer (e.g., “Decline” button 1506). The UI 1500 can be displayed on a seller user device in response to a notification received from the transaction management system that a reservation offer has been submitted for a transaction posting. In some embodiments, the UI 1500 is automatically generated when the notification is received, without the seller user device specifically requesting retrieval of the reservation offer from the transaction management system. This approach may be beneficial in embodiments where the reservation offer is configured to automatically expire after a predetermined amount of time (e.g., 48 hours after the offer has been submitted). In other embodiments, the UI 1500 can be displayed in response to a request from the seller user device, similar to the UI 900 for transaction offers described above.

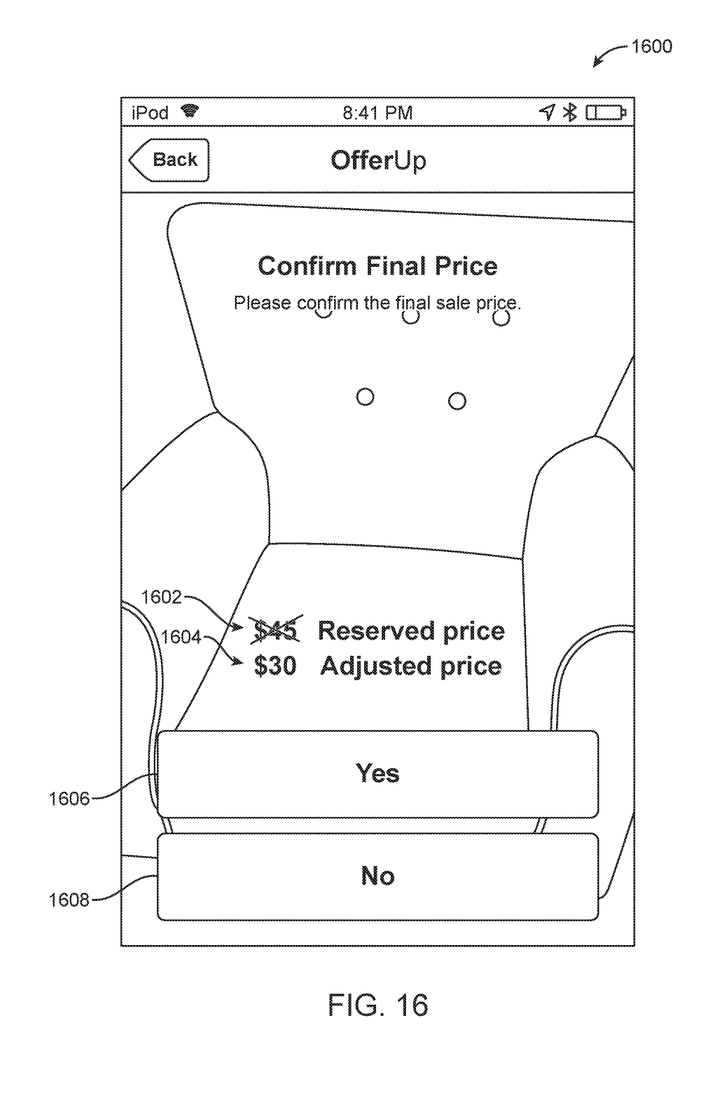

FIG. 16 illustrates a UI 1600 for authorizing a modified reserve offer payment amount, in accordance with embodiments. The UI 1600 can be displayed on a seller and/or buyer user device in response to a modification to the initial reserve offer payment amount. The UI 1600 can display the initial payment amount 1602 and the modified payment amount 1604. The UI 1600 can also include interactive elements for receiving user input to authorize the modified amount (e.g., “Yes” button 1606) or decline the modified amount (e.g., “No” button 1608). Optionally, the UI 1600 can include an input field (not shown) for receiving user input to make additional adjustments to the modified payment amount 1604.

Digital Processing Devices

As discussed above and herein, the systems, methods, and devices described herein can include one or more digital processing devices, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk chives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard, in some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In some embodiments, the systems, methods, and devices disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

In some embodiments, the systems, methods, and devices disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® NET or Ruby on Rails (RoR). In some embodiments, a web application utilizes one or more database systems including, by way of non-limiting examples, relational, non-relational, object oriented, associative, and XML database systems. in further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In sonic embodiments, a web application is written to some extent in a server-side coding language such as Active Server Pages (ASP), ColdFusion®, Peri, Java™, JavaServer Pages (JSP), Hypertext Preprocessor (PHP), Python™, Ruby, Tel, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Hash®, HTML 5, Apple® QuickTime®, Microsoft® Silverlight®, Java™, and Unity®.

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable complied applications.

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types, Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB.NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

In some embodiments, the systems, methods, and devices disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on mare than one machine. In further embodiments, software modules are hosted on cloud computing platforms. In some embodiments, software modules are hosted on one or more machines in one location. In other embodiments, software modules are hosted on one or more machines in more than one location.

In some embodiments, the systems, methods, and devices disclosed herein include one or more databases, or use of the same. In view of the disclosure provided herein, those of skill in the art will recognize that many databases are suitable far storage and retrieval of information. In various embodiments, suitable databases include, by way of non-limiting examples, relational databases, non-relational databases, object oriented databases, object databases, entity-relationship model databases, associative databases, and. XML databases. In some embodiments, a database is internet-based, In further embodiments, a database is web-based. In still further embodiments, a database is cloud computing-based. In other embodiments, a database is based on one or more local computer storage devices.

As used herein the term “and/or” is used as a functional word to indicate that two words or expressions are to be taken together or individually. For example, A and/or B encompasses A alone, B alone, and A and B together.

Unless otherwise specified, the presently described methods and processes can be performed in any order. For example, a method describing steps (a), (b), and (c) can be performed with step (a) first, followed by step (b), and then step (c). Or, the method can be performed in a different order such as, for example, with step (b) first followed by step (c) and then step (a). Furthermore, those steps can be performed simultaneously or separately unless otherwise specified with particularity. Additionally, any of the steps of the methods and processes presented herein can be added or omitted otherwise specified with particularity.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. Numerous different combinations of embodiments described herein are possible, and such combinations are considered part of the present disclosure. In addition, all features discussed in connection with any one embodiment herein can be readily adapted for use in other embodiments herein. It is intended that the following claims define the scope of the invention and that methods and structures within the scope of these claims and their equivalents be covered thereby.

What is claimed is:

1. A system for validating a computer-based local transaction using a first user device and a second user device, the system comprising:
one or more processors comprising memory configured with instructions executable by the one or more processors to cause the system to:
receive localization information from one or more of the first user device or the second user device;
process the localization information so as to determine whether the first and second user devices are in proximity to each other; and
allow the first and second user devices to conduct the local transaction if the first and second user devices are determined to be in proximity to each other.

2. The system of claim 1, wherein the first and second user devices are determined to be in proximity to each other when the processed localization information indicates that the first and second user devices are within a target distance of each other.

3. The system of claim 2, wherein the target distance is determined based on one or more of: a localization information type, an expected population density at a location where the local transaction is to be conducted, a number of other user devices at the location where the local transaction is to be conducted, or a distance between the first and second user devices when transaction data was received from the first and second user devices.

4. The system of chain 1, wherein the localization information comprises one or more of: position data, cell tower triangulation data, IP address data, or wireless access point data for one or more of the first user device or the second user device.

5. The system of claim 1, wherein the localization information comprises a signal indicating that the first and second user devices are in communication with each other over a short range communication link.

6. The system of claim 1, wherein the instructions further cause the system to generate one or more transaction parameters for the local transaction based on transaction data received from the first and second user devices, wherein the one or more transaction parameters comprise a payment amount for the local transaction.

7. The system of claim 6, wherein the one or more transaction parameters comprise a location where the local transaction is to be conducted, and wherein the instructions further cause the system to process the localization information so as to determine whether the first and second user devices are each at the location where the local transaction is to be conducted.

8. The system of claim 6, wherein the one or more transaction parameters comprise a time when the local transaction is to be conducted, and wherein the instructions further cause the system to process the localization information so as to determine whether the first and second user devices are in proximity to each other at the time when the local transaction is to be conducted.

9. The system of claim 6, wherein the one or more transaction parameters are generated prior to determining that the first and second user devices are in proximity to each other.

10. The system of claim 6, wherein the instructions further cause the system to:
detect whether authorization to perform the local transaction according to the one or more transaction parameters has been received from the first and second user devices; and
process the local transaction according to the one or more transaction parameters by causing transfer of the payment amount, in response to the received authorization.

11. The system of claim 10, wherein the one or more transaction parameters comprise a payment method for the local transaction, and wherein the local transaction is processed by causing the transfer of the payment amount according to the payment method.

12. The system of claim 10, wherein the system detects whether the authorization has been received in response to determining that the first and second user devices are in proximity to each other based on the processed localization information.

13. The system of claim 6, wherein the instructions further cause the system to:
modify the one or more transaction parameters in response to a request received from one or more of the first user device or the second user device;
detect whether authorization to perform the local transaction according to the modified one or more transaction parameters has been received from the first and second user devices; and
process the local transaction according to the modified one or more transaction parameters, in response to the received authorization.

14. The system of claim 13, wherein the modified one or more transaction parameters comprise a modified payment amount different from the payment amount, and wherein the local transaction is processed by causing transfer of the modified payment amount.

15. The system of claim 14, wherein the modified payment amount is fess than the payment amount.

16. The system of claim 14, wherein the modified payment amount is greater than the payment amount.

17. The system of claim 13, wherein the one or more transaction parameters comprise a first payment method for the local transaction, the modified one or more transaction parameters comprise a second payment method different from the first payment method, and the local transaction is processed by causing the transfer of the payment amount according to the second payment method.

18. The system of claim 6, wherein the instructions further cause the system to:
cause the payment amount to be transferred from an account associated with one of the first user device or second user device to a reserve account, in response to the generated one or more transaction parameters; and
process the local transaction by causing transfer of be payment amount from the reserve account.

19. The system of claim 18, wherein the instructions further cause the system to transmit a notification to one or more of the first user device or the second user device indicating that the payment amount has been transferred to the reserve account.

20. The system of claim 18, wherein the instructions further cause the system to:
modify the payment amount in response to a request received from one or more of the first user device or the second user device;
detect whether authorization to perform the local transaction according to the modified payment amount has been received from the first and second user devices; and
process the local transaction by causing transfer of the modified payment amount, wherein at least some of the modified payment amount is transferred from the reserve account.

21. The system of claim 1, wherein the first and second user devices each comprise a local application, and wherein the one or more processors are configured to communicate with the first and second user devices with the respective local applications.

22. The system of claim 1, wherein the first and second. user devices each comprise a mobile application, and wherein the one or more processors are configured to communicate with the first and second user devices with the respective mobile applications.

23. A method for validating a computer-based local transaction using a first user device and a second user device, the method comprising:
receiving localization information from one or more of the first user device or the second user device;
processing the localization information so as to determine whether the first and second user devices are in proximity to each other; and
allowing the first and second user devices to conduct the local transaction if the first and second user devices are determined to be in proximity to each other.

24. A system for conducting a computer-based local transaction using a first user device and a second user device, the system comprising:
one or more processors comprising memory configured with instructions executable by the one or more processors to cause the system to:
generate one or more transaction parameters for the local transaction based on transaction data received from the first and second user devices, wherein the one or more transaction parameters comprise a payment amount for the local transaction;
modify the one or more transaction parameters in response to a request received from one or more of the first user device or the second user device;
detect whether authorization to perform the local transaction according to the modified one or more transaction parameters has been received from the first and second user devices; and
process the local transaction according to the modified one or more transaction parameters, in response to the received authorization.

25. The system of claim 24, wherein the modified one or more transaction parameters comprise a modified payment amount different from the payment amount, and wherein the local transaction is processed by causing transfer of the modified payment amount.

26. The system of claim 25, wherein the modified payment amount is less than the payment amount.

27. The system of claim 25, wherein the modified payment amount is greater than the payment amount.

28. The system of claim 24, wherein the one or more transaction parameters comprise a first payment method for the local transaction, the modified one or more transaction parameters comprise a second payment method different from the first payment method, and the local transaction is processed by causing the transfer of the payment amount according to the second payment method.

29. The system of claim 24 wherein the instructions further cause the system to:
cause the payment amount to be transferred from an account associated with one of the first user device or second user device to a reserve account, in response to the generated one or more transaction parameters.

30. The system of claim 29, wherein the instructions further cause the system. to transmit a notification to one or more of the first user device or the second user device indicating that the payment amount has been transferred to the reserve account.

31. The system of claim 29, wherein the instructions further cause the system to process the local transaction by causing transfer of the modified payment amount, wherein at least some of the modified payment amount is transferred from the reserve account.

32. The system of claim 24 wherein the instructions further cause the system to process localization information received from one or more of the first user device or the second user device so as to determine whether the first and second user devices are in proximity to each other.

33. The system of claim 32, wherein be first and second user devices are determined to be in proximity to each other when the processed localization information indicates that the first and second user devices are within a target distance of each other.

34. The system of claim 33, wherein the target distance is determined based on one r more of: a localization information type, an expected population density at a location where the local transaction is to be conducted, a number of other user devices at the location where the local transaction is to be conducted, or a distance between the first and second user devices when the transaction data was received.

35. The system of chain 32, wherein the localization information comprises one or more of: position data, cell tower triangulation data, IP address data, or wireless access point data for one or more of the first user device or the second user device.

36. The system of claim 32, wherein the localization information comprises a signal indicating that the first and second user devices are in communication with each other over a short range communication link.

37. The system of claim 32, wherein the one or more transaction parameters comprise a location where the local transaction is to be conducted, and wherein the instructions further cause the system to process the localization information so as to determine whether the first and second user devices are each at the location where the local transaction is to be conducted.

38. The system of claim 32, wherein the one or more transaction parameters comprise a time when the local transaction is to be conducted, and wherein the instructions further cause the system to process the localization information so as to determine whether the first and second user devices are in proximity to each other at the time when the local transaction is to be conducted.

39. The system of claim 32, wherein the one or more transaction parameters are generated prior to determining that the first and second user devices are in proximity to each other.

40. The system of claim 24, wherein the first and second user devices each comprise a local application, and wherein the one or more processors are configured to communicate with the first and second user devices with the respective local applications.

41. The system of claim 24, wherein the first and second user devices each comprise a mobile application, and wherein the one or mare processors are configured to communicate with the first and second user devices with the respective mobile applications.

42. A method far conducting a computer-based local transaction using a first user device and a second user device, the method comprising:
generating one or more transaction parameters for the local transaction based on transaction data received from the first and second user devices, wherein the one or more transaction parameters comprise a payment amount for the local transaction;
modifying the one or more transaction parameters in response to a request received from one or more of the first user device or the second user device;
detecting whether authorization to perform the local transaction according to the modified one or more transaction parameters has been received from the first and second user devices; and
processing the local transaction according to the modified one or more transaction parameters, in response to the received authorization.

43. A system for validating a computer-based local transaction using a first user device and a second user device, the system comprising:
one or more processors comprising memory configured with instructions executable by the one or more processors to cause the system to:
generate one or more transaction parameters for the local transaction based on transaction data received from the first and second user devices, wherein the one or more transaction parameters comprise a payment amount for the local transaction;
generate one or more digital tokens based on the one or more transaction parameters; and
transmit the one or more digital tokens to each of the first and second user devices,
wherein the one or more digital tokens are configured with instructions to permit the first and second user devices to conduct the local transaction in response to the first and second user devices exchanging and validating their respective digital tokens with each other.

44. The system of claim 43, wherein the one or more digital tokens are configured with instructions to permit the first and second user devices to conduct the local transaction independently of the one or more processors when each of the first and second user devices has received the one or more digital tokens.

45. The system of claim 43, wherein the one or snore digital tokens are configured with instructions to permit the first and second user devices to conduct the local transaction without being connected to the one or more processors when each of the first and second user devices has received the one or more digital tokens.

46. The system of claim 43, wherein the one or more digital tokens comprise one or more transaction requirements for the local transaction, and wherein the one or more digital tokens are configured with instructions to permit the first and second user devices to conduct the local transaction in response to a determination that the one or more transaction requirements have been fulfilled.

47. The system of claim 46, wherein the one or more transaction requirements comprise one or more of: the first and second user devices being in proximity to each other, the local transaction occurring at a predetermined, location, the local transaction occurring at a predetermined time, a maximum payment amount for the local transaction, or a minimum payment amount for the local transaction.

48. A method for validating a computer-based local transaction using a first user device and a second user device, the method comprising:
generating one or more transaction parameters for the local transaction based on transaction data received from the first and second user devices, wherein the one or more transaction parameters comprise a payment amount for the local transaction;
generating one or more digital tokens based on the one or more transaction parameters; and
transmitting the one or more digital tokens to each of the first and second user devices,
wherein the one or more digital tokens are configured with instructions to permit the first and second user devices to conduct the local transaction in response to the first and second user devices exchanging and validating their respective digital tokens with each other.

49. A system for validating a computer-based local transaction using a first user device and a second user device, the system comprising:
one or more processors comprising memory configured with instructions executable by the one or more processors to cause the system to:
generate one or more transaction parameters for the local transaction based on transaction data received from the first and second user devices, wherein the one or more transaction parameters comprise a payment amount for the local transaction;
generate one or more security codes based on the one or more transaction parameters; and
transmit the one or more security codes to each of the first and second user devices,
wherein the one or more security codes are configured to permit the first and second user devices to conduct the local transaction in response to the first and second user devices exchanging and validating their respective security codes with each other.

50. A method for validating a computer-based local transaction using a first user device and a second user device, the method comprising:
generating one or more transaction parameters for the local transaction based on transaction data received from the first and. second user devices, wherein the one or more transaction parameters comprise a payment amount for the local transaction;
generating one or more security codes based on the one or more transaction parameters; and
transmitting the one or more security codes to each of the first and second user devices,
wherein the one or more security codes are configured to permit the first and second user devices to conduct the local transaction in response to the first and second user devices exchanging and validating their respective security codes with each other.

51. A method, the method comprising providing a system as in any one of claims 1-22, 24-41, 43-47, or 49.

52. A system for improving reliability of a computer-based local transaction using a first user device and a second user device, the system comprising:
one or more processors comprising memory configured with instructions executable by the one or more processors to cause the system to:
generate one or more transaction parameters for the local transaction based on transaction data received from the first and second user devices, wherein the one or more transaction parameters comprise a payment amount for the local transaction.

53. A method for improving reliability of a computer-based local transaction using a first user device and a second user device, the method comprising:
generating one or more transaction parameters for the local transaction based on transaction data received from the first and second user devices, the one or more transaction parameters comprising a payment amount for the local transaction.

54. A mobile device for improving reliability of a computer-based local transaction conducted with a second mobile device, the mobile device comprising:
one or more processors comprising memory configured with instructions executable by the one or more processors to cause the mobile device to:
generate transaction data for a local transaction, wherein the transaction data comprises a payment amount for the local transaction, and
transmit the transaction data to a server.

55. The mobile device of claim 54, wherein the mobile device is configured with the instructions to:
receive one or more digital tokens from the server;
transmit the one or more digital tokens to the second mobile device;
receive and validate a second one or more digital tokens from the second mobile device; and
conduct the local transaction in res o validation of the second one or more digital tokens.

56. A mobile device for improving reliability of a computer-based local transaction with a second mobile device, the mobile device comprising:
a display comprising a user interface configured to receive a user input;
one or more processors comprising memory configured with instructions executable by the one or more processors to cause the mobile device to:
receive the user input, and
transmit a signal to the second mobile device in response to the user input.

57. A system for improving reliability of a computer-based local transaction using a first user device and a second user device, the system comprising:
one or more processors comprising memory configured with instructions executable by the one or more processors to provide a user interface on a display of one or ore of the first user device or the second user device.
